(19) United States
(12) Patent Application Publication
(10) Pub. No.: US 2013/0103184 A1
(43) Pub. Date: Apr. 25, 2013

(54) Molding Machine

(71) Applicants: Tatsunori Morikawa, Akashi-shi (JP); Eiji Kiyota, Akashi-shi (JP); Hiromichi Kuroda, Akashi-shi (JP); Sachiko Shimotani, Akashi-shi (JP); Kenji Fujii, Akashi-shi (JP)

(72) Inventors: Tatsunori Morikawa, Akashi-shi (JP); Eiji Kiyota, Akashi-shi (JP); Hiromichi Kuroda, Akashi-shi (JP); Sachiko Shimotani, Akashi-shi (JP); Kenji Fujii, Akashi-shi (JP)

(73) Assignee: TOYO MACHINERY & METAL CO LTD, HYOGO (JP)

(21) Appl. No.: 13/807,624

(22) PCT Filed: Jun. 28, 2011
(86) PCT No.: PCT/JP2011/064782

§ 371 Date: Dec. 28, 2012

(30) Foreign Application Priority Data
Jun. 30, 2010 (JP) 2010-149954

(51) Int. Cl. B29C 45/76

(52) U.S. Cl. CPC B29C 45/76
USPC 700/197

(57) ABSTRACT

A molding machine is provided for easily setting molding conditions. Molding navigation is stored in a microcomputer portion for performing drive control of the molding machine. When the molding navigation is activated, a plurality of setting screens required for setting molding conditions are displayed in a predetermined sequence on a display portion, and in each of the displayed setting screens, setting item display fields to which the molding conditions are to be input are displayed in a color different from the surrounding. An operator inputs predetermined setting values in the displayed sequence in the setting item display fields displayed in the color different from the surrounding. Thereby, the setting of the molding conditions can be completed. All molding conditions required for operating the molding machine can be set exhaustively, and the setting of the molding conditions can be performed highly efficiently and reliably, without special skills.

### TECHNICAL FIELD

The present invention relates to a molding machine such as an injection molding machine or a die casting machine. Particularly, it relates to a configuration of a molding condition setting device for setting molding conditions.

### BACKGROUND ART

In a molding machine such as an injection molding machine or a die casting machine, a molding condition setting device for setting molding conditions is provided additionally. It is necessary to input required molding conditions by operating the molding condition setting device before operation of the molding machine. The setting of the molding conditions however requires skill because the molding conditions in the molding machine are diversified. It is difficult for an unskilled person to perform the setting work efficiently with respect to all necessary setting items.

As a technique of relaxing the difficulty in such a work of setting molding conditions, there has been heretofore proposed a control apparatus of an injection molding machine in which various kinds of molding condition setting items are classified and allocated to a plurality of screens each of which is displayed on a display so that setting values of various kinds of molding conditions are inputted, set and displayed, wherein: a screen selection key and a next page key are provided in the control apparatus of the injection molding machine; a screen setting unit for arbitrarily setting, changing and storing correspondence of screens to be displayed correspondingly to operation of the screen selection key and operation of the next page key and the screen selection key is provided so that each of the screens set and stored by the screen setting unit correspondingly to the operation of the screen selection key and the operation of the next page key and the screen selection key is displayed on the display by the operation (e.g. see Patent Literature 1). According to the invention described in Patent Literature 1, a display screen used frequently can be allocated correspondingly to single operation of the screen selection key by a condition setting method or operator's preference, so that an operation of selecting a display screen at the time of setting the conditions can be simplified.

There has been heretofore proposed also an apparatus having: a learning processing unit which learns transitional patterns formed from a plurality of continuous setting items necessary for an operator to set molding conditions in a learning mode, and records the transitional patterns as a transitional pattern table on a recording device; and a setting item selection processing unit which selects a setting item and makes a setting field in a setting screen wait for inputting (e.g. see Patent Literature 2). According to the invention described in Patent Literature 2, a next setting item can be selected automatically in accordance with a transitional pattern learned in a learning mode when molding conditions are set, so that an operation for setting the molding conditions can be simplified.

There has been heretofore proposed a further apparatus in which a specific setting item to be displayed on a display is displayed in a specific color or number so that the display in the specific color or number is turned off when the setting value of the specific setting item is changed or when the same value is inputted again as the setting value of the specific setting item (e.g. see Patent Literature 3). According to the invention described in Patent Literature 3, an operator can easily recognize whether setting of molding conditions in a specific setting item has been performed or not, by viewing the display, so that it is possible to prevent the operator from forgetting to change the setting value.

### CITATION LIST

### Patent Literature

Patent Literature 1: JP-A-Hei-5-42571
Patent Literature 2: JP-A-2008-114403
Patent Literature 3: Japanese Patent 4094194

### SUMMARY OF INVENTION

### Technical Problem

In any one of the techniques described in Patent Literatures 1 to 3, it is however necessary for the operator to repeat an operation of displaying a desired setting screen on a display, selecting a desired setting item from the setting screen and inputting a setting value in the selected setting item, with respect to all necessary setting items. Accordingly, it is hardly said that the operation for setting molding conditions is simplified sufficiently. There is still a room for such greater improvement that even an unskilled person can set molding conditions easily.

Either of the techniques described in Patent Literatures 1 and 2 is effective in the case where one and the same operator repeats setting of molding conditions in one and the same molding machine, but is poor in operability instead in the case where another operator performs setting of molding conditions newly so that setting, etc. of the display screen performed by the previous operator is not fit for the new operator's preference, condition setting method, etc.

The present invention is accomplished in consideration of the aforementioned point and an object of the invention is to provide a user-friendly molding machine in which even an unskilled person can set molding conditions easily.

### Solution to Problem

To solve the aforementioned problem, according to the invention, there is provided a molding machine for repeating respective processes of mold closing, injection, mold opening and product taking-out according to a control signal outputted from a control portion, having a display portion, an input portion and a storage portion for setting molding conditions which are conditions for driving respective portions of the molding machine in the respective processes, configured in that: the storage portion stores a molding condition automatic setting mode for automatically setting the molding conditions; and the control portion performs control of switching a screen displayed on the display portion to a first setting screen of the molding condition automatic setting mode and color-displaying display fields of setting items for inputting the molding conditions in the first setting screen when an operator operates the input portion to select the molding condition automatic setting mode from a menu screen displayed on the display portion, and of switching the screen displayed on the display portion to a second setting screen of the molding condition automatic setting mode and color-displaying display fields of setting items for inputting the molding conditions in the second setting screen when the operator operates the input portion to select a next display request field displayed in the first setting screen, up to a final setting screen.

In this manner, when the molding condition automatic setting mode stored in the storage portion is activated, a plurality of setting screens required for setting the molding conditions are displayed in a predetermined sequence on the display portion and display fields of setting items in which the molding conditions are to be inputted in each of the displayed setting screens are color-displayed (displayed in a color different from the surrounding so that an operator can recognize the display fields visually easily). Accordingly, the operator can automatically find the setting items of the molding conditions and the input procedure thereof, so that all the molding conditions required for operating the molding machine can be set exhaustively without requiring any special skill. Accordingly, the setting of the molding conditions can be performed highly efficiently and reliably.

According to the invention, the molding machine configured as described above is configured in that when the molding condition automatic setting mode is selected, the control portion switches the screen displayed on the display portion to an initial screen of the molding condition automatic setting mode and successively displays a selection field as to whether all setting values to be inputted in accordance with the molding condition automatic setting mode are set to zero or not, and a selection field as to whether the molding condition automatic setting mode is terminated or not, as part of the initial screen before switching the screen displayed on the display portion to the first setting screen.

When “set to zero” is selected, the operator himself/herself can perform inputting in all setting items to be inputted in accordance with the molding condition automatic setting mode. Accordingly, the work of setting the molding conditions can be made efficient without the necessity of erasing the previous setting values one by one. When “not set to zero” is selected, new setting values can be inputted while the previous setting values are utilized. Accordingly, the work of setting the molding conditions can be made efficient. On the other hand, when “terminate the molding condition automatic setting mode” is selected, the screen displayed on the display portion goes back to the menu screen. Accordingly, the work of setting the molding conditions can be made efficient for a skilled person experienced in a manual setting method using the menu screen. When “not terminate the molding condition automatic setting mode” is selected, the work of setting the molding conditions can be performed in accordance with the molding condition automatic setting mode. Accordingly, the work of setting the molding conditions can be made efficient for an unskilled person as described above. In this manner, by displaying required selection fields as part of the initial screen in the molding condition automatic setting mode, the work of setting the molding conditions can be diversified so that the molding machine can be provided as a user-friendly molding machine for a lot of operators.

According to the invention, the molding machine configured as described above is configured in that display of an option confirmation screen, display of a mold clamping force calculation and stroke calculation screen, display of an exchange screen, display of a temperature setting screen, display of a mold opening/closing and product taking-out screen and display of an injection and plasticization screen are performed in this order as display of the setting screens in the automatic setting mode.

The injection molding machine performs molding of a molded article by repeating respective processes of raw material resin plasticization, mold closing, molten resin injection, mold opening and product taking-out. Accordingly, when an option confirmation screen, a mold clamping force calculation and stroke calculation screen, an exchange screen, a temperature setting screen, a mold opening/closing and product taking-out screen and an injection and plasticization screen are displayed successively on the display portion and required setting values of setting items displayed in the respective screens are set, it is possible to mold a good article.

According to the invention, the molding machine configured as describe above is configured in that the control portion displays a description field of a relevant item as part of each of the setting screens.

In this manner, when the description field of a relevant item is displayed as part of each of the setting screens, the operator can learn or confirm relevant knowledge with respect to the respective setting screens. Accordingly, the work of setting the molding conditions can be performed more efficiently and an educational effect for an unskilled person can be fulfilled.

According to the invention, the molding machine configured as described above is configured in that core, air and mold opening/closing option selection fields are displayed in the mold opening/closing and product taking-out screen; and when one of the selection fields is selected by operation of the input portion, the control portion switches the screen displayed on the display portion to one of a core setting screen, an air setting screen and a mold opening/closing option setting screen in accordance with the selected selection field.

In molding of a molded article using a molding machine, there are various special modes such as a mode using a core and a mode of executing air blowing. When respective selection fields of core, air and mold opening/closing option are used in the mold opening/closing and product taking-out screen, molding conditions for molding in these special modes can be set. Accordingly, the original function of the molding machine is not reduced to bring excellent general-purpose properties.

According to the invention, the molding machine configured as described above is configured in that: a plasticization assist selection field and an option confirmation selection field are displayed in the injection and plasticization screen; when the plasticization assist selection field is selected by operation of the input portion, the control portion switches the screen displayed on the display portion to a plasticization assist setting screen; and when the option confirmation selection field is selected by operation of the input portion, the control portion switches the screen displayed on the display portion to an option confirmation screen.

In the final stage of the plasticization process, V-P switching is performed to switch screw drive control to pressure control from velocity control so that a predetermined retained pressure is given to the molten resin packed in a mold cavity to prevent the shape of a molded article from becoming poor. The plasticization assist is provided mainly for inputting setting values required for the V-P switching control. When the plasticization assist setting screen is displayed as another setting screen than the injection and plasticization screen on the display portion, setting values required for the V-P switching control can be inputted more easily and reliably. The option confirmation is provided for confirming contents of the currently selected option. When this screen is displayed on the display portion, excess and deficiency of the option to be set can be found. In addition, the injection and plasticization screen is a screen displayed on the display portion in the final stage of setting. Accordingly, when an option confirmation selection field is displayed on this screen, it is easy to go back from the injection and plasticization screen to the option confirmation screen so that use can be made convenient.

According to the invention, the molding machine configured as described above is configured in that: a previous display request field is displayed in each of the first to last setting screens; and when the operator operates the input portion to select the previous display request field, the control portion switches the screen displayed on the display portion to a previous setting screen.

According to such a configuration, when the operator selects the previous display request field at the time of execution of the molding condition automatic setting mode, it is possible to go back to the previous screen at pleasure so that it is possible to prevent the operator from forgetting to confirm the setting values set in the previous screen or make setting.

According to the invention, the molding machine configured as described above is configured in that: an indicator indicating the progress of the molding condition automatic setting mode is displayed in each of the first to last setting screens; and whenever the setting screen displayed on the display portion is switched, the color of the indicator is changed correspondingly to the setting screen after switching.

According to such a configuration, the operator can understand the stage to which setting of molding conditions in the molding condition automatic setting mode has gone, by taking one look at the indicator, so that use of the molding condition automatic setting mode can be made convenient.

According to the invention, the molding machine configured as described above is configured in that: the control portion performs control of color-displaying all display fields of setting items simultaneously and color-displaying a heading field of a first setting item for inputting the molding conditions when the setting screen having the display fields of setting items is displayed on the display portion, and canceling the color-display of the heading field of the first setting item and color-displaying a heading field of a second setting item when the operator operates the input portion to select a next display request field displayed in the setting screen, up to display of the last setting item; when the operator operates the input portion to select a next display request field displayed in the setting screen while a heading field of the last setting item is color-displayed, the control portion switches the screen displayed on the display portion to a next setting screen; when the operator operates the input portion to select a previous display request field displayed in the setting screen while a heading field of the second setting item or a setting item after the second setting item is color-displayed, the control portion cancels the color-display of the heading field of the second setting item or the setting item after the second setting item and color-displays the heading field of the previous setting item; and when the operator operates the input portion to select a previous display request field displayed in the setting screen while the heading field of the first setting item is color-displayed, the control portion switches the screen displayed on the display portion to a previous setting screen.

In the case where a setting screen having display fields of setting items is displayed on the display portion, the operator can find all setting items to which the molding conditions are to be inputted, by seeing the screen displayed on the display portion when all the display fields of setting items are color-displayed simultaneously. Accordingly, all required molding conditions can be inputted exhaustively. When heading fields of predetermined setting items to which the molding conditions are to be inputted are color-displayed successively whenever the next display request field or the previous display request field displayed in the setting screen is selected, the operator can automatically find the procedure of inputting the molding conditions, so that the work of inputting required molding conditions can be performed easily.

### Advantageous Effects of Invention

According to the invention, when a molding condition automatic setting mode is activated, setting screens required for setting molding conditions are displayed in a predetermined sequence on the display portion and setting item display fields in which the molding conditions are to be inputted in the displayed setting screens are color-displayed in a color different from the surrounding. Accordingly, the operator can complete the setting of the molding conditions by a simple operation of inputting predetermined setting values in the displayed sequence in the color-displayed setting item display fields. Accordingly, all the molding conditions required for operating the molding machine can be set exhaustively without requiring any special skill, so that the setting of the molding conditions can be performed highly efficiently and reliably.

### BRIEF DESCRIPTION OF DRAWINGS

FIG. 1 A configuration view of an injection molding machine according to an embodiment.

FIG. 2 A block diagram showing conceptually various kinds of information provided in the injection molding machine according to the embodiment.

FIG. 3 A view showing a menu screen.

FIG. 4 A flow chart showing a procedure of setting molding conditions in a molding condition automatic setting mode.

FIG. 5 A view showing an initial screen in the molding condition automatic setting mode.

FIG. 6 A view showing a first inquiry screen which appears on the initial screen in the molding condition automatic setting mode.

FIG. 7 A view showing a second inquiry screen which appears on the initial screen in the molding condition automatic setting mode.

FIG. 8 A view showing an option confirmation screen.

FIG. 9 A view showing a calculation screen.

FIG. 10 A view showing an exchange screen.

FIG. 11 A view showing a description field of mold clamping force which appears on the exchange screen.

FIG. 12 A view showing a temperature setting screen.

FIG. 13 A view showing a description of a nozzle which appears on the temperature setting screen.

FIG. 14 A view showing a description of a front heater which appears on the temperature setting screen.

FIG. 15 A view showing a description of a center heater which appears on the temperature setting screen.

FIG. 16 A view showing a description of a rear/rearmost heater which appears on the temperature setting screen.

FIG. 17 A view showing a description of an under-hopper heater which appears on the temperature setting screen.

FIG. 18 A view showing a mold opening/closing and EJ screen.

FIG. 19 A view showing a description of mold opening setting which appears on the mold opening/closing and EJ screen.

FIG. 20 A view showing a description of mold closing setting which appears on the mold opening/closing and EJ screen.

FIG. 21 A view showing a description of ejector setting which appears on the mold opening/closing and EJ screen.

FIG. 22 A view showing a core screen.

FIG. 23 A view showing an air screen.

FIG. 24 A view showing a mold opening/closing option screen.

FIG. 25 A view showing a description of low pressure mold clamping which appears on the mold opening/closing and EJ screen.

FIG. 26 A view showing an injection and plasticization screen.

FIG. 27 A view showing a description of plasticization which appears on the injection and plasticization screen.

FIG. 28 A view showing a plasticization assist screen.

FIG. 29 A view showing a description of suck-back which appears on the injection and plasticization screen.

FIG. 30 A view showing a description of injection velocity which appears on the injection and plasticization screen.

FIG. 31 A view showing a description of primary pressure which appears on the injection and plasticization screen.

FIG. 32 A view showing a description of holding pressure setting which appears on the injection and plasticization screen.

FIG. 33 A view showing a description of secondary pressure switching mode which appears on the injection and plasticization screen.

FIG. 34 A view showing a description of timer which appears on the injection and plasticization screen.

FIG. 35 A view showing a description of secondary pressure switching setting which appears on the injection and plasticization screen.

FIG. 36 A view showing a description of cooling timer which appears on the injection and plasticization screen.

### DESCRIPTION OF EMBODIMENTS

An embodiment of a molding machine according to the invention will be described below with reference to the drawings.

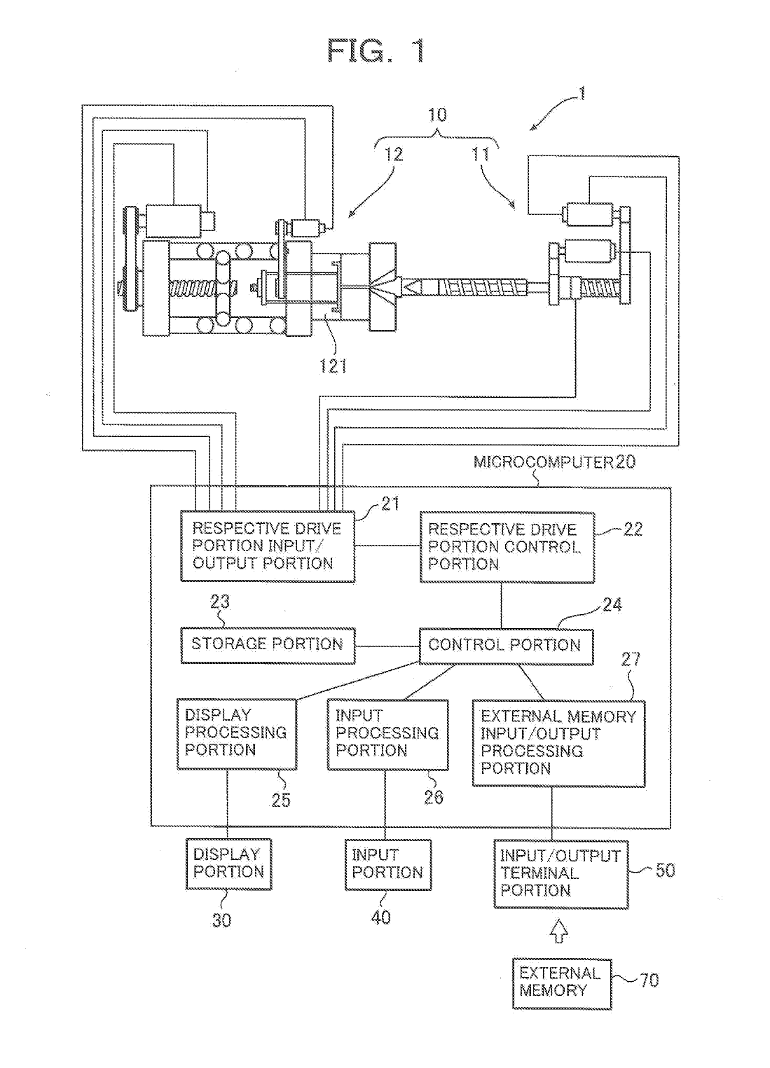

FIG. 1 shows a configuration of an injection molding machine according to an embodiment. The injection molding machine 1 according to this example has: a molding mechanism portion 10 which molds an article by mechanical operation; a microcomputer portion 20 which performs operation control of the molding mechanism portion 10, etc.; a touch panel which serves both as a display portion 30 which is an output interface for an operator, and as an input portion 40 which is an input interface for receiving an input from the operator; and an input/output terminal portion 50 which is a terminal for connecting an external memory, etc.

The molding mechanism portion 10 is roughly classified into an injection unit 11 and a mold clamping unit 12. The mold clamping unit 12 is mainly used for opening/closing a mold 121. The injection unit 11 is used for plasticizing a resin material (pellet) and injecting the molten resin into a cavity of the mold 121. Each unit is provided with a plurality of servomotors which supply motive power to respective drive portions. Each servomotor is provided with an encoder so that operation control is performed while the operating state of each motor is fed back.

The microcomputer portion 20 has: a respective drive portion input/output portion 21 which inputs/outputs a signal to each motor or each encoder; a respective drive portion control portion 22 which performs control, etc. of the signal inputted/outputted from the respective drive portion input/output portion 21 (i.e. control of each drive portion); a storage portion 23 which stores molding conditions, etc.; a control portion 24 which performs control, etc. of the machine as a whole; a display processing portion 25 which performs control, etc. of the display portion 30; an input processing portion 26 which performs discrimination, etc. of a signal from the input portion 40; an external memory input/output processing portion 27 which performs processing, etc. of the signal inputted/outputted from the input/output terminal portion 50; etc.

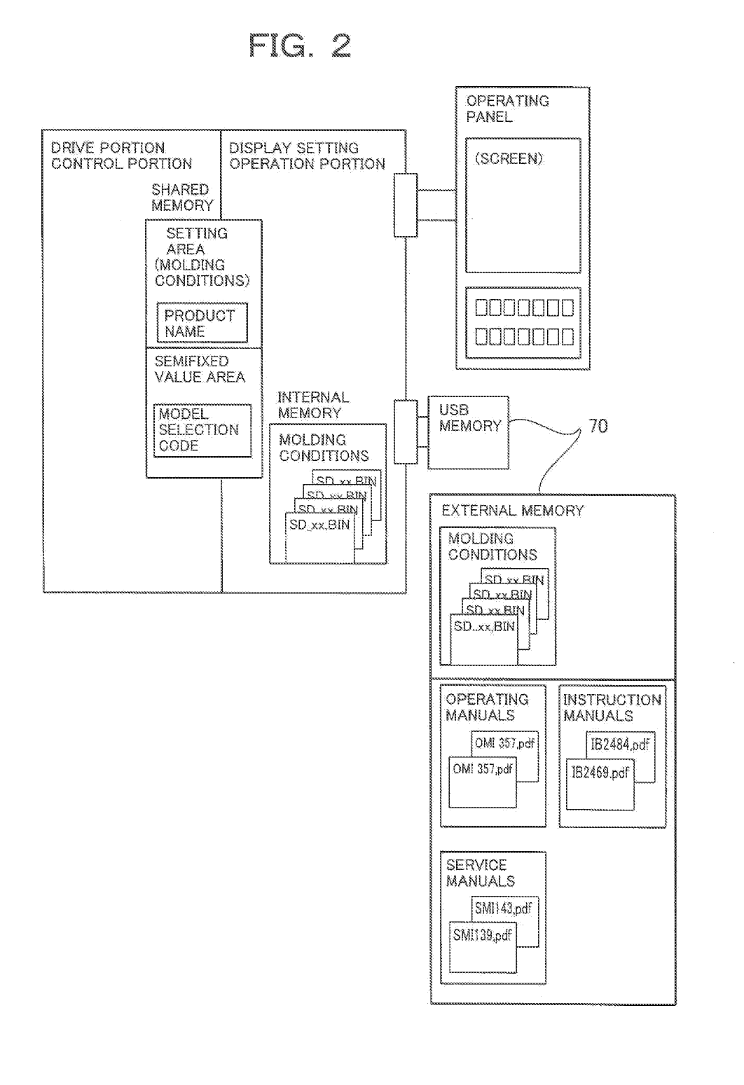

FIG. 2 shows various kinds of information provided in the injection molding machine 1 according to this embodiment. As is obvious from this drawing, a plurality of molding condition files corresponding to molds 121 (the product names of molded articles and the models of molding machines) provided in the mold clamping unit 12 are stored in an internal memory of the storage portion 23. The molding condition files are files for storing various kinds of setting values for determining operating conditions of the molding mechanism portion 10. Incidentally, the molding condition files may be stored in an external memory 70 connected to the input/output terminal portion 50. For molding a product by the injection molding machine 1, any one of such molding condition files is selected to thereby set molding conditions based on the molding condition file in a shared memory (e.g. a register in the control portion 24), and the respective drive portion control portion 22 controls the molding mechanism portion 10 based on the conditions to thereby perform molding of the product.

A model selection code is set in a nonvolatile memory portion (shared memory) of the storage portion 23. The model selection code in this embodiment is information allocated to a machine regarded as identifiable. In this embodiment, there is a model code which is information allocated to each machine model. For example, because machines may be minutely different in specifications even when the machines are of the same model (i.e. of the same model code), the model selection code is allocated in accordance with such difference in specifications. In this embodiment, the model code is provided as information of a numerical value of four figures, and the model selection code is provided as information of a numerical value of eight figures obtained by further adding a numerical value of four figures to the model code. Incidentally, “model identification information” in Claims is not limited to any one of the model code and the model selection code exemplified here. In a way, “minute difference in specifications” can be regarded as model difference. The point is that it is a concept defined in accordance with “on what basis machines are regarded as of the same model”.

A molding condition setting area is provided in the nonvolatile memory portion of the storage portion 23. Molding condition setting screens of a plurality of pages are stored in the setting area. Setting of the molding conditions is performed in such a manner that the setting screens of the pages stored in the storage portion 23 are displayed successively on the display portion 30 and the input portion 40 is used for inputting a required setting value in a setting item field displayed in each setting screen. The injection molding machine according to this embodiment is characterized in that a manual setting mode, that is, a method in which the operator suitably selects a setting screen to be displayed on the display portion 30 and inputs a required setting value for a necessary setting item, and an automatic setting mode, that is, a method in which required setting screens are displayed in a predetermined sequence on the display portion 30 in accordance with an instruction from the microcomputer portion 20 and the operator is urged to input a setting value for a setting item displayed on each setting screen (molding navigation which will be described later), can be selected arbitrarily as molding condition setting modes.

A molding condition setting method in the injection molding machine according to this embodiment will be described below.

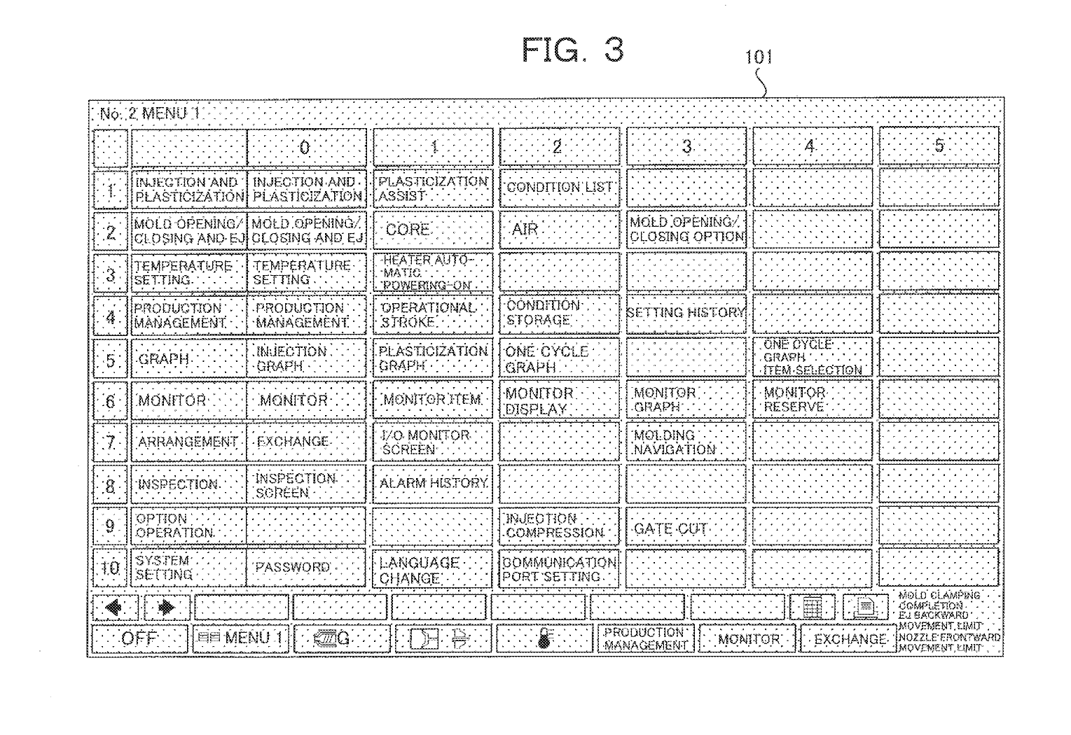

When the microcomputer 20 is activated, a menu screen 101 shown in FIG. 3 is displayed on the display portion 30. The menu screen 101 in this example is separated into ten items “1. injection and plasticization”, “2. mold opening/closing and EJ (an abbreviation of EJECT; product taking-out)”, “3. temperature setting”, “4. production management”, “5. graph”, “6. monitor”, “7. arrangement”, “8. inspection”, “9. option operation” and “10. system setting”. Two to five selection buttons are provided for each item. A selection button of “molding navigation” is provided in “7. arrangement”. When the operator operates the input portion 40 to select the “molding navigation”, the setting moves to molding condition setting in the aforementioned automatic setting mode. When the operator selects another selection button, a setting screen corresponding to the kind of the selected button is displayed on the display portion 30 to enable molding condition setting in the aforementioned manual setting mode. Because the molding condition setting in the manual setting mode is a matter belonging to public knowledge and not the gist of the invention, description thereof will be omitted.

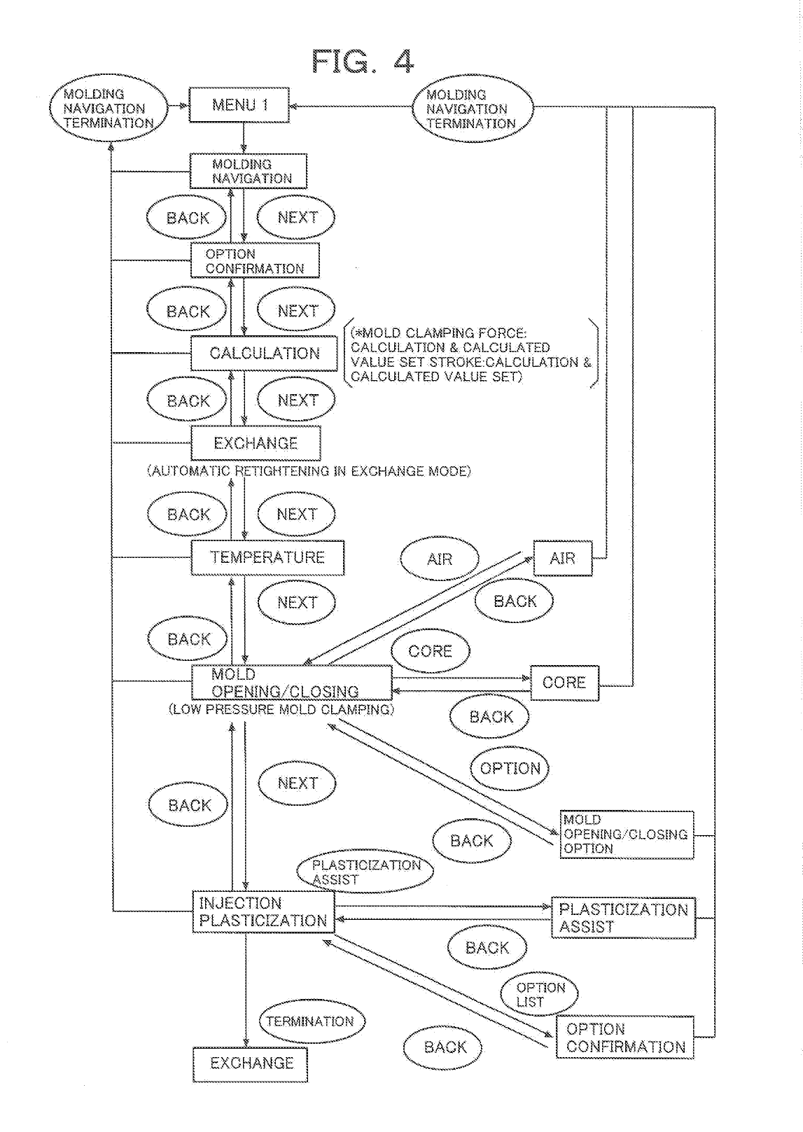

Setting of molding conditions in the case where “molding navigation” is selected goes on in accordance with a procedure of a flow chart shown in FIG. 4. That is, when “next” requesting next display (next display request field) is selected after the menu screen shown in FIG. 3 is switched to an initial screen of “molding navigation”, the screen displayed on the display portion 30 is switched to an option confirmation screen, a calculation screen, an exchange screen, a temperature screen, a mold opening/closing screen and an injection and plasticization screen successively. Incidentally, in the case where a plurality of setting items are displayed in one screen, the setting item in one and the same screen is changed from the current setting item to a next setting item when the operator selects “next”. This will be described later in detail. In the mold opening/closing screen, selection fields (selection buttons) of an air screen, a core screen and a mold opening/closing screen are provided so that the current screen is automatically changed to any one of the air screen, the core screen and the mold opening/closing screen correspondingly when the operator selects a desired selection field. In the injection and plasticization screen, selection fields (selection buttons) of plasticization assist and option confirmation are provided so that the current screen is automatically changed to either of the plasticization assist screen and the option confirmation screen correspondingly when the operator selects a desired selection field. Accordingly, even an unskilled person can input molding conditions in necessary items easily and successively.

In each of the aforementioned screens, “back” (previous display request field) requesting previous display is displayed so that the screen displayed on the display portion 30 is changed to a previous setting screen when the operator selects “back”. Incidentally, in the case where a plurality of setting items are displayed in one screen, the setting item in one and the same screen is changed from the current setting item to a previous setting item when the operator selects “back”. This will be described later in detail.

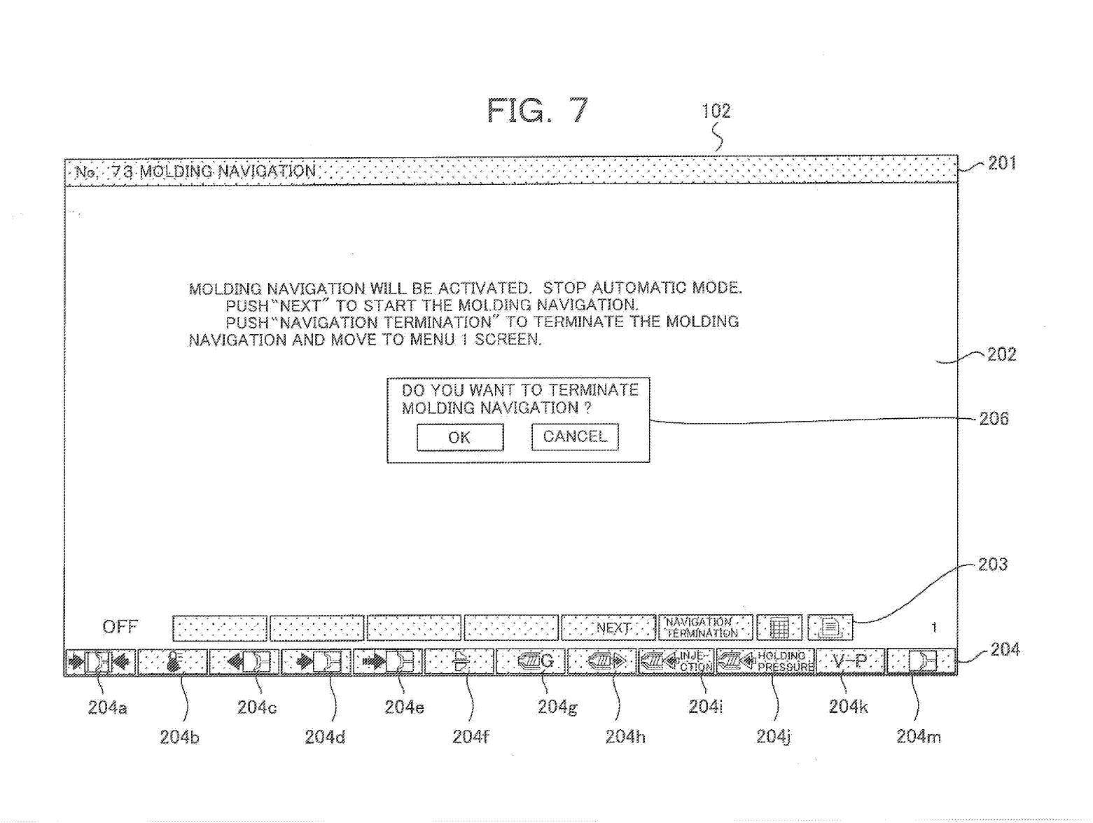

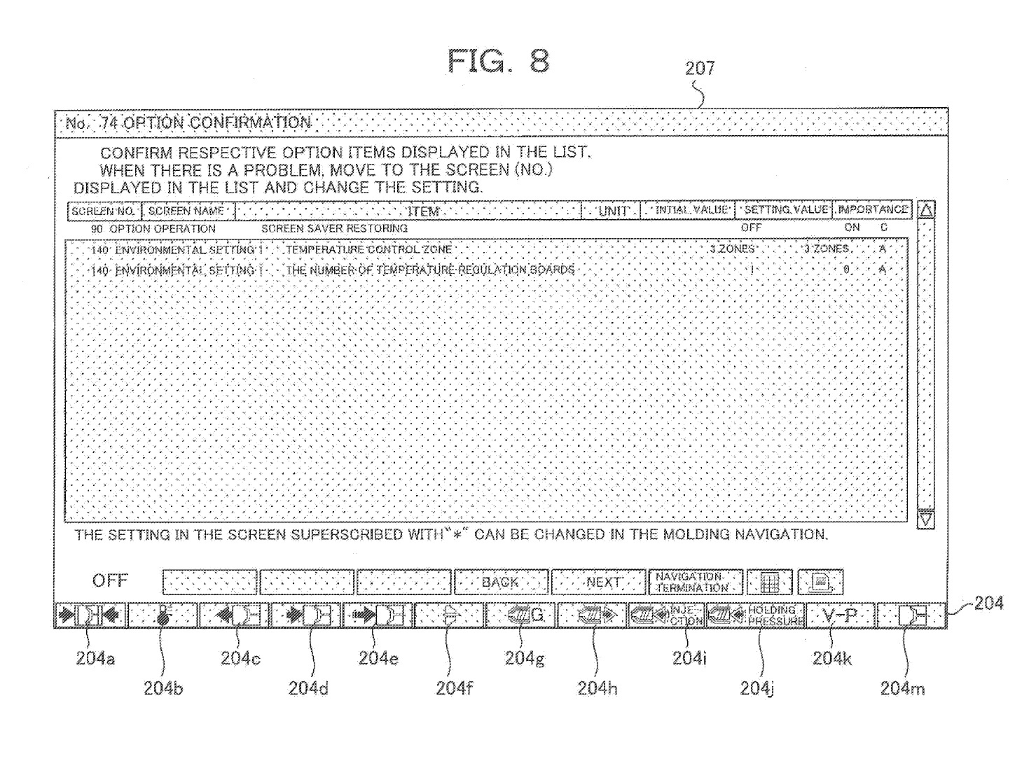

In each of the molding navigation initial screen, the option confirmation screen, the calculation screen, the exchange screen, the temperature screen, the mold opening/closing screen, the injection and plasticization screen, the air screen, the core screen, the mold opening/closing screen and the plasticization assist screen, a selection field (selection button) of “navigation termination” is provided so that the molding navigation can be terminated from any screen when the operator selects “navigation termination”. When the operator selects “navigation termination”, an inquiry screen 206 “Do you want to terminate molding navigation?” is displayed on the display screen as exemplified in FIG. 7. When “OK” in the inquiry screen 206 is selected, the molding navigation is terminated and the menu screen 101 shown in FIG. 3 is displayed on the display portion 30. When “CANCEL” in the inquiry screen 206 is selected, the molding navigation is continued so that an option confirmation screen 207 shown in FIG. 8 is displayed on the display portion 30.

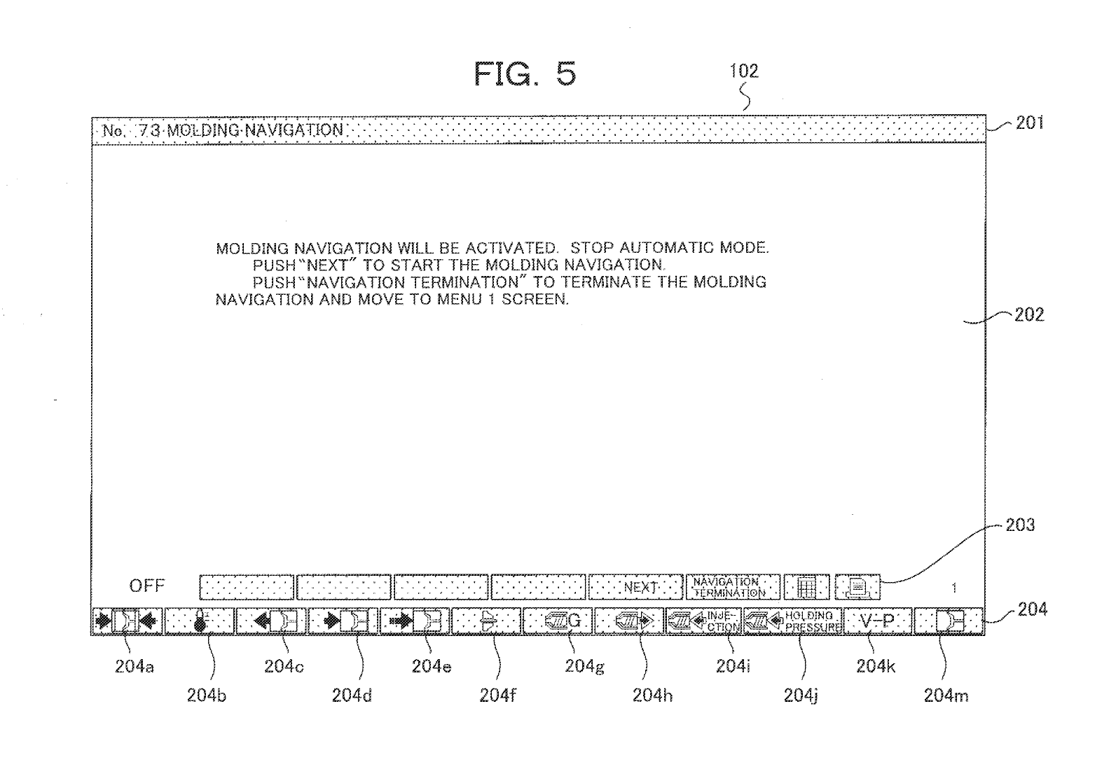

The aforementioned molding condition setting procedure will be described below more in detail with reference to FIGS. 5 to 36.

When “molding navigation” is selected from the menu screen 101 in FIG. 3, the screen displayed on the display portion 30 is switched to an initial screen 102 in FIG. 5. A title field 201 where the title of the screen, the model of the injection molding machine, the date and time, etc. are displayed, a content display field 202 where characters “Molding navigation will be activated. Stop the automatic mode. Push “next” to start molding navigation. Push “navigation termination” to terminate molding navigation and move to MENU1 screen.” are displayed, a selection button field 203 where buttons “next”, “navigation termination”, etc. are displayed, and an indicator 204 indicating the progress of molding navigation, are displayed in the initial screen 102. Although not shown, configuration may be made in such a manner that a selection switch for reading a description of molding navigation is displayed in the initial screen 102 so that the description of molding navigation can be displayed in the initial screen 102 when the operator pushes down the selection switch.

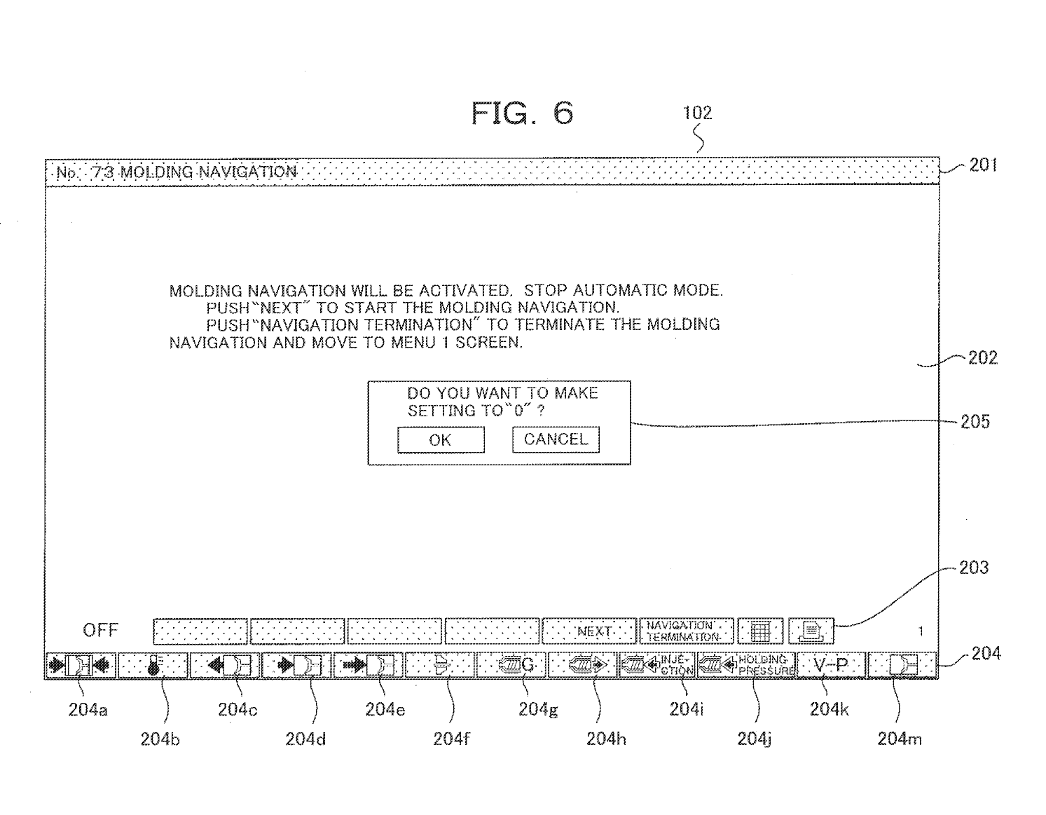

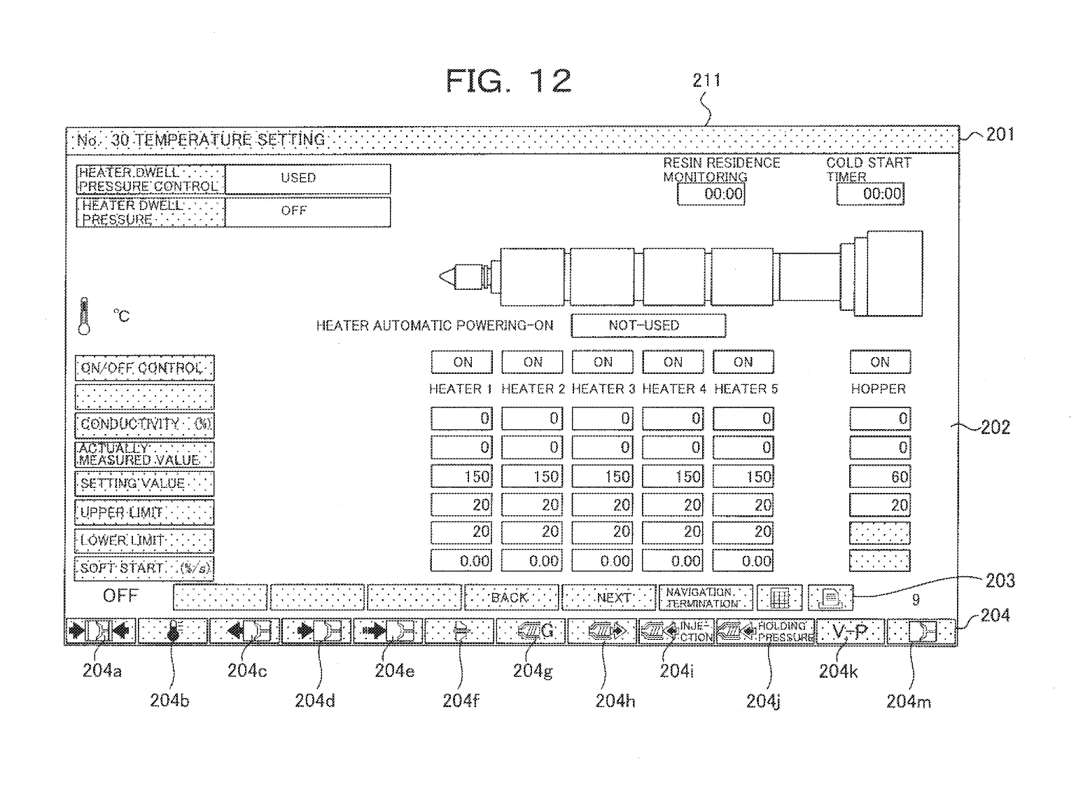

When “next” displayed in the menu screen 101 is pushed down, molding navigation is activated so that an inquiry screen 205 “Do you want to make setting to zero?” is displayed in the initial screen 102, as shown in FIG. 6. “Make setting to zero” means that the current setting value in each of items whose setting values are to be set by using the molding navigation is set to zero. When “OK” in the inquiry screen 205 is selected, the setting values in preset setting items among the current setting values can be set to zero. In this embodiment, configuration is made so that the current setting values of monitoring time, monitoring torque and EJ count in a low pressure mold clamping region in a mold opening/closing and EJ screen 217 shown in FIG. 8 and heater setting temperature and under-hopper temperature in a temperature setting screen 211 shown in FIG. 12 are not set to zero even when “OK” in the inquiry screen 205 is selected. When the current setting values of predetermined setting items are set to zero collectively thus, the operator himself/herself can input setting values without the necessity of erasing the previous setting values one by one with respect to the predetermined setting items to be inputted in accordance with the molding navigation so that the work of setting the molding conditions can be made efficient. When “CANCEL” in the inquiry screen 205 is selected, all the current setting values are held and the previous setting values can be used for setting of new setting values so that the work of setting the molding conditions can be made efficient.

When the “next” button displayed in the initial screen 102 of the molding navigation is pushed down, the screen displayed on the display portion 30 is changed to the option confirmation screen 207 shown in FIG. 8. In the option confirmation screen 207, one item or a plurality of items set optionally are listed. The operator can confirm whether necessary option items are listed or not, by seeing the option confirmation screen 207. Although FIG. 8 shows the example where only the temperature control zone and the number of temperature regulation boards are listed as option items, the gist of the invention is not limited thereto.

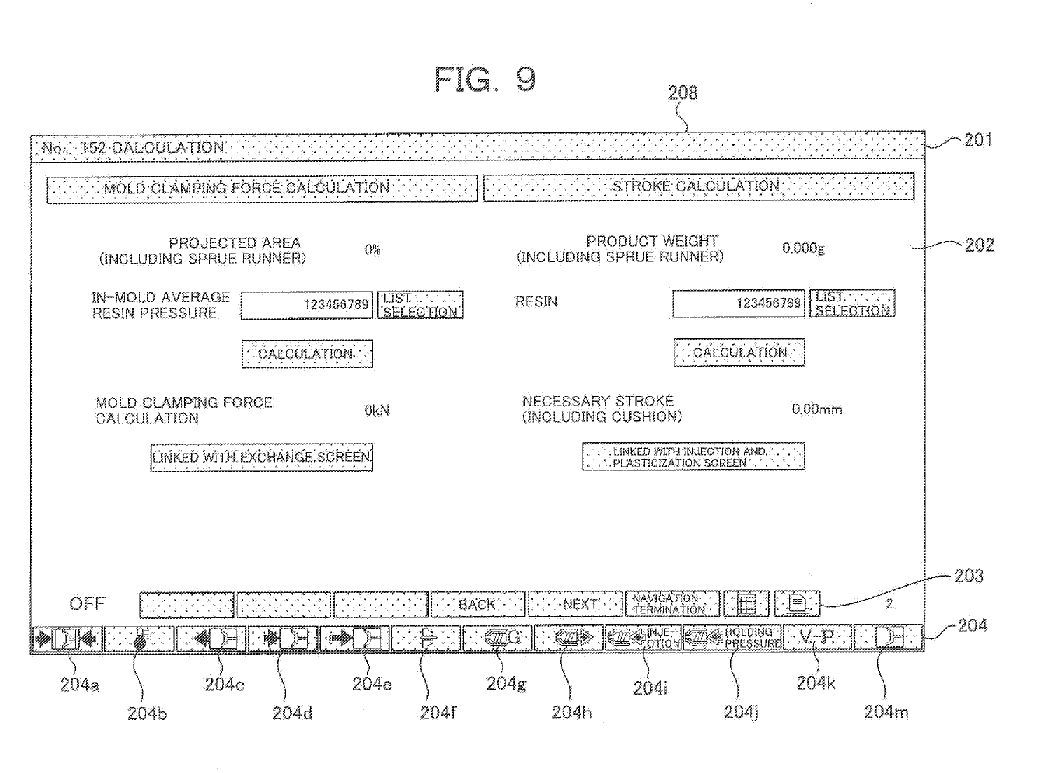

When the operator selects “next” displayed in the option confirmation screen 207, a calculation screen 208 shown in FIG. 9 is displayed on the display portion 30. In the calculation screen 208, a heading field of “mold clamping force calculation” and a heading field of “stroke calculation” are displayed below the title field 201, a projected area setting field is displayed as a setting item display field below the heading field of “mold clamping force calculation”, and an in-mold average resin pressure list selection button, a mold clamping force calculation button for giving an instruction to start calculation of mold clamping force, a calculated mold clamping force value display field for displaying the calculated mold clamping force and a “linked with exchange screen” button for reflecting the calculated mold clamping force value on the exchange screen are displayed further below the projected area setting field. On the other hand, a product weight setting field is displayed as a setting item display field below a heading field of “stroke calculation”, and a resin material list selection button, a necessary stroke calculation button for giving an instruction to start necessary stroke calculation, a calculated necessary stroke value display field for displaying the calculated necessary stroke and a “linked with the injection and plasticization screen” button for reflecting the calculated necessary stroke value on the injection and plasticization screen are displayed further below the product weight setting field.

When the display on the display portion 30 is changed to the calculation screen 208, the heading field of “mold clamping force calculation”, the projected area setting field, the mold clamping force calculation button, the “linked with the exchange screen” button, the product weight setting field, the necessary stroke calculation button and the “linked with the injection and plasticization screen” button are first color-displayed in a color different from the surrounding. The operator sets the projected area of the molded article in the projected area display field by using the input portion 40 while referring to the color display. When the projected area of the molded article is set, the color display of the projected area setting field is canceled and the setting value is displayed in the projected area display field. Accordingly, the operator can find completion of the inputting of the setting value in the projected area display field. Then, the operator pushes down the in-mold average resin pressure list selection button to display candidates for in-mold average resin pressure on the display screen, and selects a suitable one from the displayed candidates. The selected value is displayed in the in-mold average resin pressure display field. Then, when the calculation button is selected, mold clamping force is calculated automatically and displayed in the mold clamping force calculation display field. Thus, mold clamping force calculation is completed. Then, the “linked with the exchange screen” button is pushed down so that the obtained mold clamping force calculation is reflected on the exchange screen. When the “next” button displayed in the calculation screen 208 is pushed down after the completion of the mold clamping force calculation, the color display of the heading field of “mold clamping force calculation” is canceled and the heading field of “stroke calculation” is color-displayed. Then, the operator inputs the product weight of the molded article in the product weight display field by using the input portion 40. When the product weight of the molded article is inputted, the color display of the product weight setting field is canceled and the setting value is displayed in the product weight display field. Accordingly, the operator can find completion of the inputting of the setting value in the product weight display field. Then, the operator pushes down the resin material list selection button to display candidates for resin material on the display screen, and selects a suitable one from the displayed candidates. The selected material name is displayed in the resin material display field. When the calculation button is then selected, the necessary stroke is calculated automatically and displayed in the necessary stroke display field. Thus, stroke calculation is completed. Then, the “linked with the injection and plasticization screen” button is pushed down so that the obtained stroke calculation is reflected on the injection and plasticization screen.

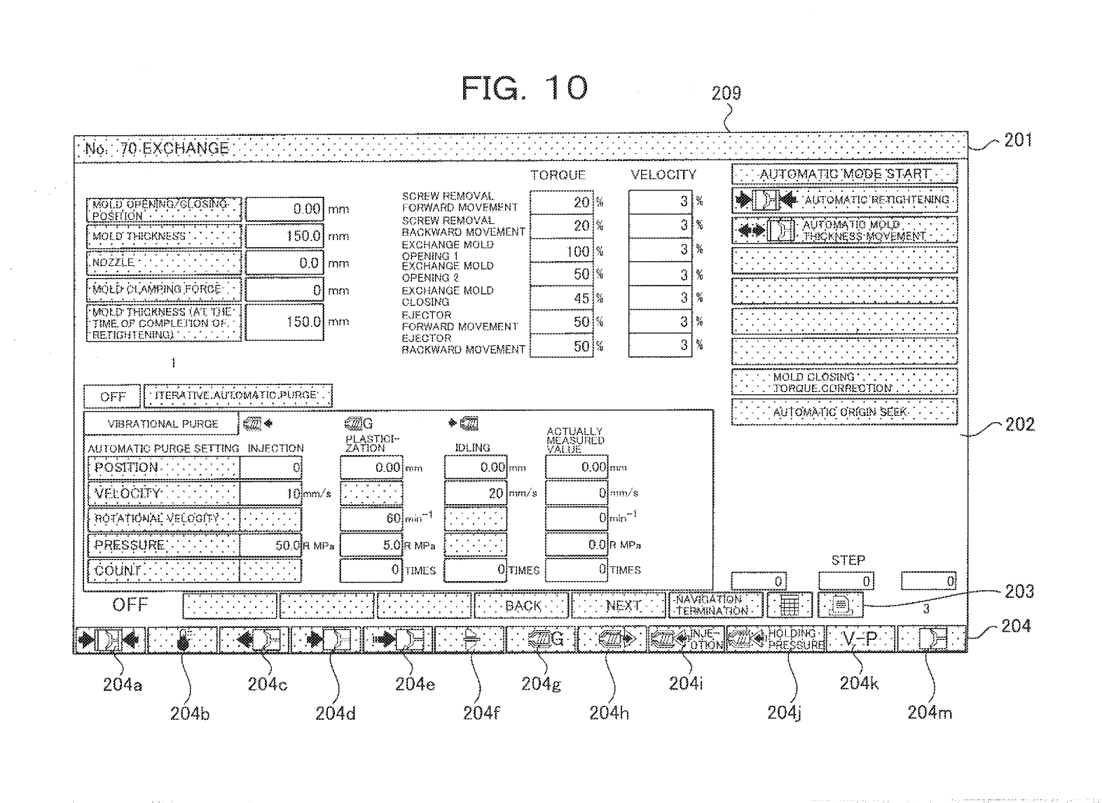

When the “next” button displayed in the calculation screen 208 is pushed down after the completion of the stroke calculation, the screen displayed on the display portion 30 is changed to an exchange screen 209 shown in FIG. 10. Incidentally, when the “back” button displayed in the calculation screen 208 is pushed down after the completion of the stroke calculation, the color display of the heading field of “stroke calculation” is canceled and the heading field of “mold clamping force calculation” is color-displayed. When the “back” button displayed in the calculation screen 208 is pushed down in the condition that the heading field of “mold clamping force calculation” is color-displayed, the screen displayed on the display portion 30 is changed to the option confirmation screen 207 shown in FIG. 8.

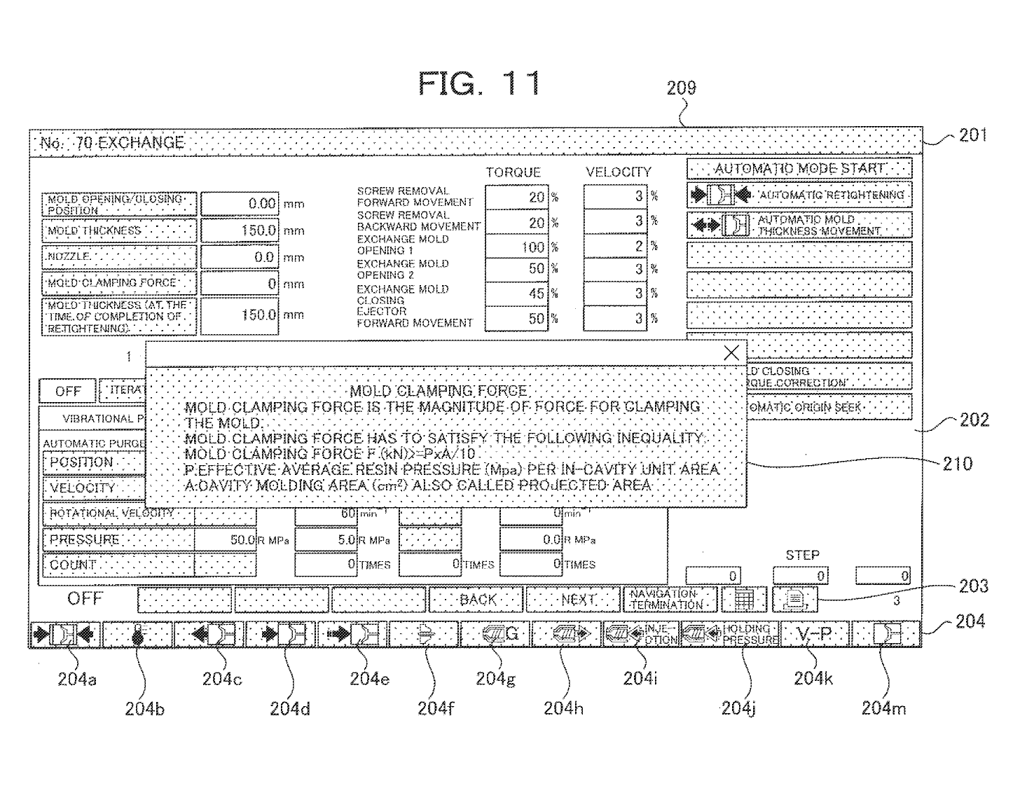

The exchange screen 209 is a screen displayed at the time of exchange of a mold, a screw, etc. As shown in FIG. 10, respective display fields of mold opening/closing position, mold thickness, nozzle, mold clamping force, mold thickness, screw removal forward movement, screw removal backward movement, exchange mold opening 1, exchange mold opening 2, exchange mold closing, ejector forward movement and ejector backward movement are displayed. As iterative automatic purging, respective display fields of automatic purging position, velocity, rotational velocity, pressure and count are displayed. Further, an automatic retightening button, an automatic mold thickness moving button, a mold closing torque correction button and an automatic origin seek button are displayed as function buttons. When the heading field of mold clamping force displayed in the exchange screen 209 is pushed down by operation of the input portion 40 after the screen displayed on the display portion 30 is changed to the exchange screen 209, a description 210 of mold clamping force is displayed as a relevant item as shown in FIG. 11. When the operator selects an “X” mark displayed in the description 210, the description 210 disappears and the current screen goes back to the exchange screen 209 in FIG. 10.

When the screen displayed on the display portion 30 goes back to the exchange screen 209, only the mold clamping force display field of the exchange screen 209 is color-displayed in a color different from the surrounding. Accordingly, the operator inputs a required setting value in the mold clamping force display field by using the input portion 40 while referring to the color display. Incidentally, when the “linked with the exchange screen” button displayed in the calculation screen 208 is operated so that the mold clamping force calculated by use of the calculation screen 208 is reflected on the exchange screen 209, it is unnecessary to set mold clamping force on the exchange screen 209. When the “next” button displayed in the exchange screen 209 is then pushed down, the automatic retightening button on the exchange screen 209 is color-displayed in a color different from the surrounding. Accordingly, the operator pushes down the automatic retightening button. Thus, retightening in the injection molding machine is performed automatically, so that the setting of the setting values in the exchange screen 209 is completed. At the same time, the color of automatic retightening display 204a of the indicator 204 changes to a color different from a color in the surrounding to thereby indicate that setting of the molding conditions using the molding navigation has gone to automatic retightening. Incidentally, when the operator pushes down “next” displayed in the exchange screen 209 without execution of automatic retightening, an alarm for urging “Execute automatic retightening once.” is displayed in the exchange screen 209. When the operator pushes down “next” again, the screen displayed on the display portion 30 is changed to the temperature setting screen 211 shown in FIG. 12. When the screen is changed to the temperature setting screen 211, the color of temperature display 204b of the indicator 204 changes to the color in a color different from the color in the surrounding to thereby indicate that setting of the molding conditions using the molding navigation has gone to temperature setting.

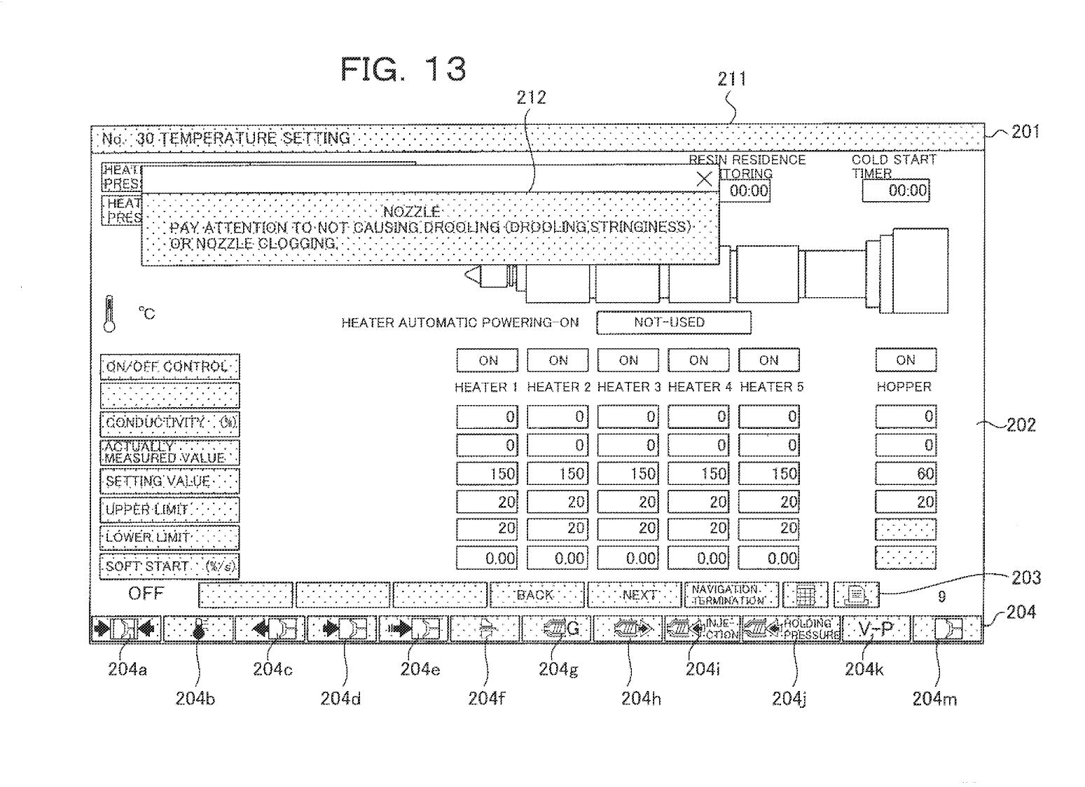

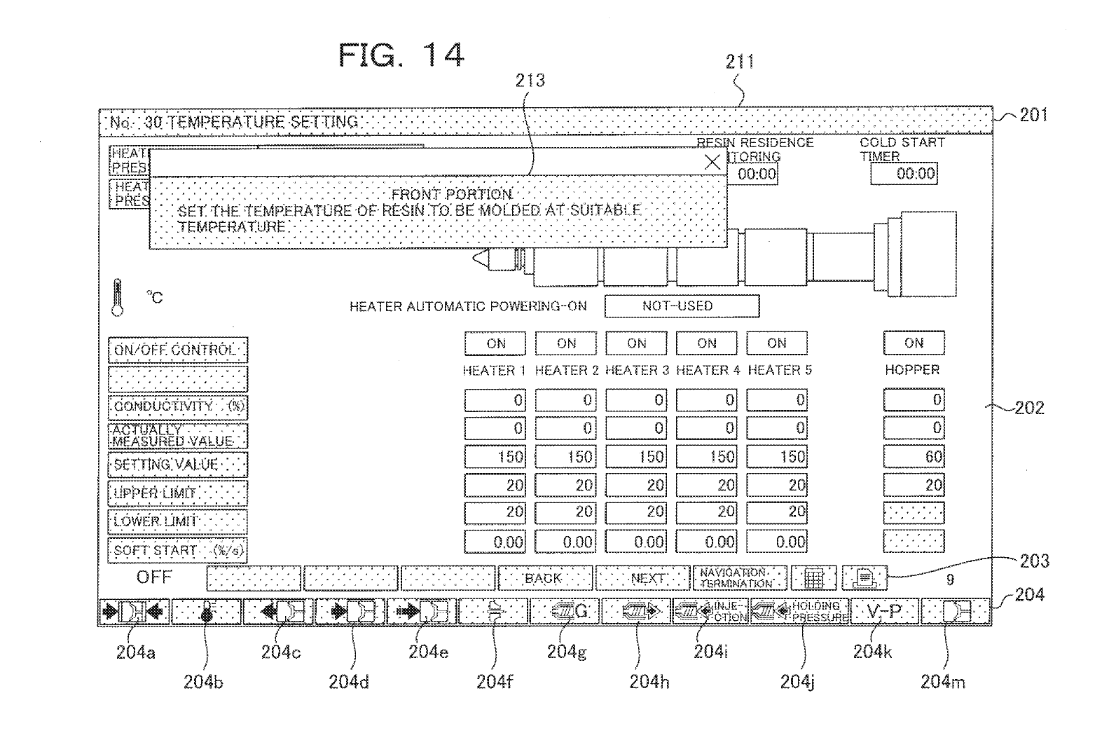

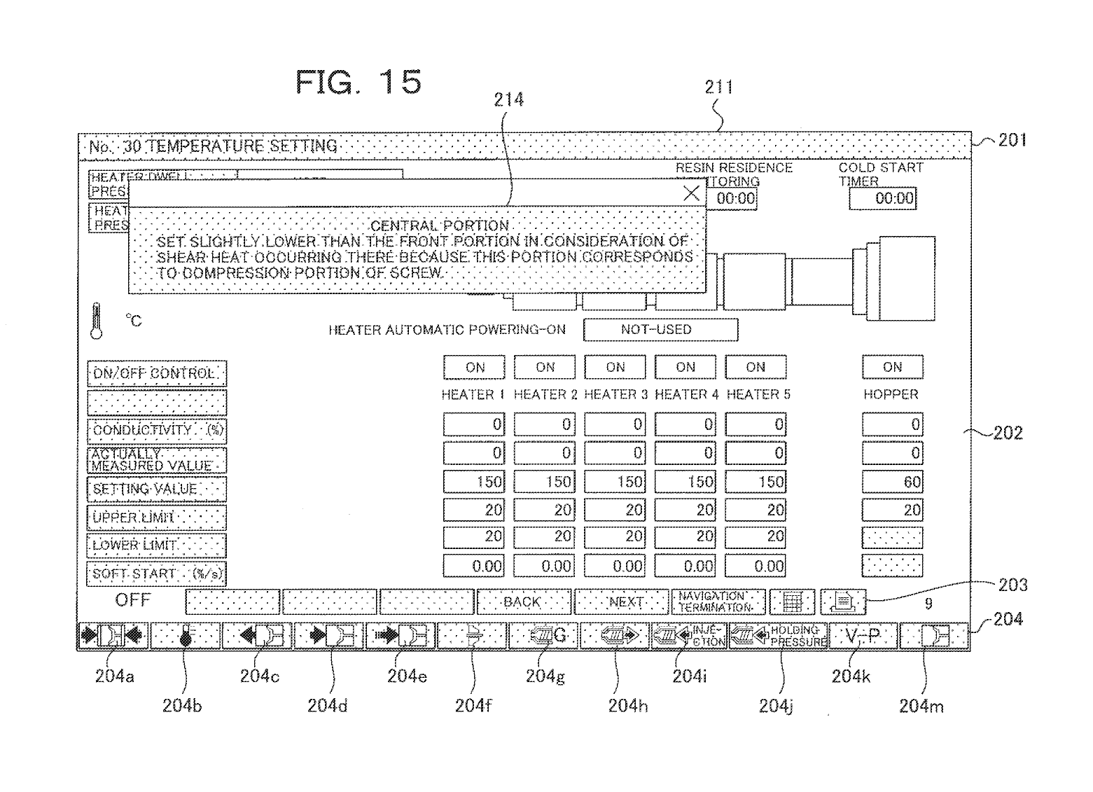

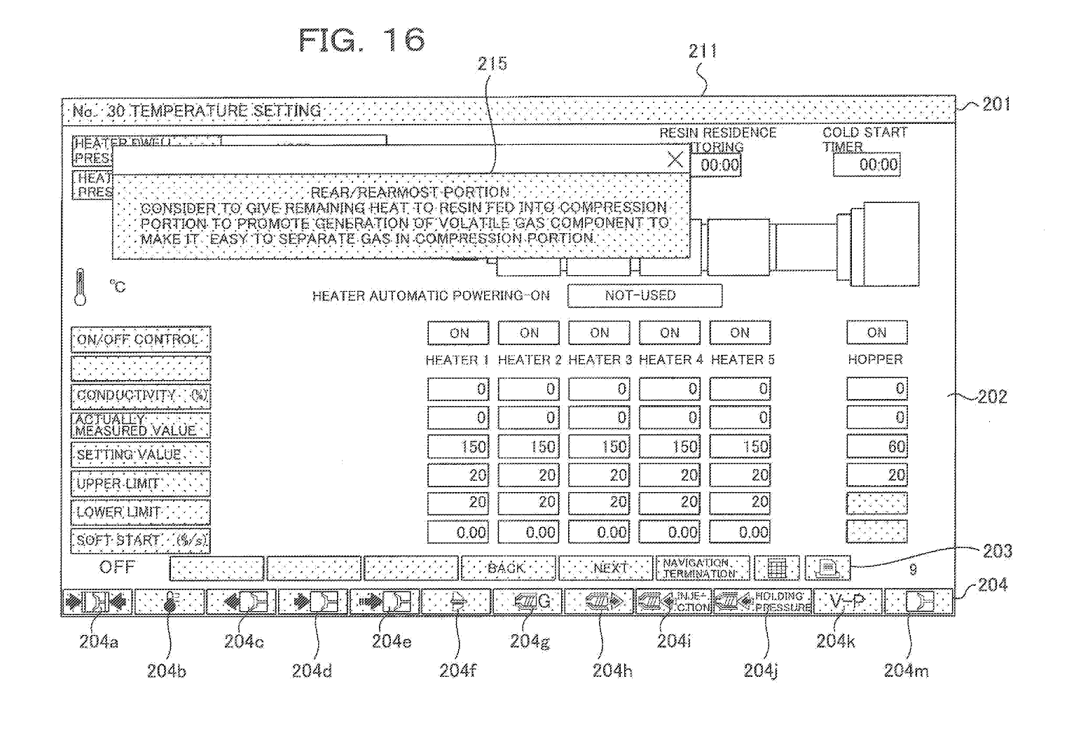

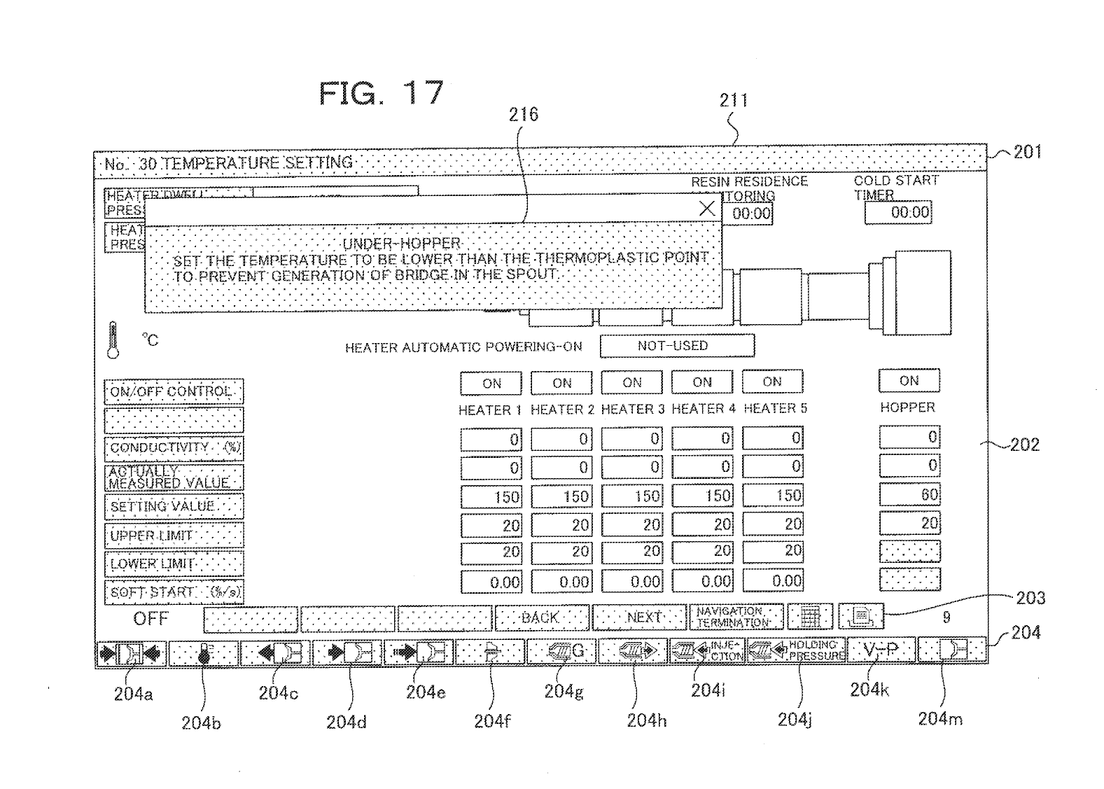

The temperature setting screen 211 is a screen for setting heating conditions of band heaters wound around an injection cylinder and heating conditions of a hopper. As shown in FIG. 12, a view showing arrangement of the band heaters 1 to 5, respective display fields of ON/OFF control, electric conductivity, actually measured value, setting value, upper limit, lower limit, soft start, resin residence monitoring and cooling activation timer and respective selection fields of heater warming-up control, heater warming-up and heater automatic powering-on are displayed. When “heater 1” displayed in the temperature setting screen 211 is selected by the input portion 40 after the screen displayed on the display portion 30 is changed to the temperature setting screen 211, a description 212 of nozzle is displayed as a relevant item in the temperature setting screen 211 as shown in FIG. 13. By pushing down an “X” mark displayed in the right upper portion, this description 212 can be erased from the screen. Similarly, when “heater 2”, “heater 3”, “heater 4” or “hopper” displayed in the temperature setting screen 211 is selected, a description 213 of a front heater shown in FIG. 14, a description 214 of a center heater shown in FIG. 15, a description 215 of a rear/rearmost heater shown in FIG. 16 or a description 216 of an under-hopper heater shown in FIG. 17 is displayed as each relevant item. By pushing down an “X” mark displayed in the right upper portion, each of the descriptions 213 to 216 can be erased from the screen.

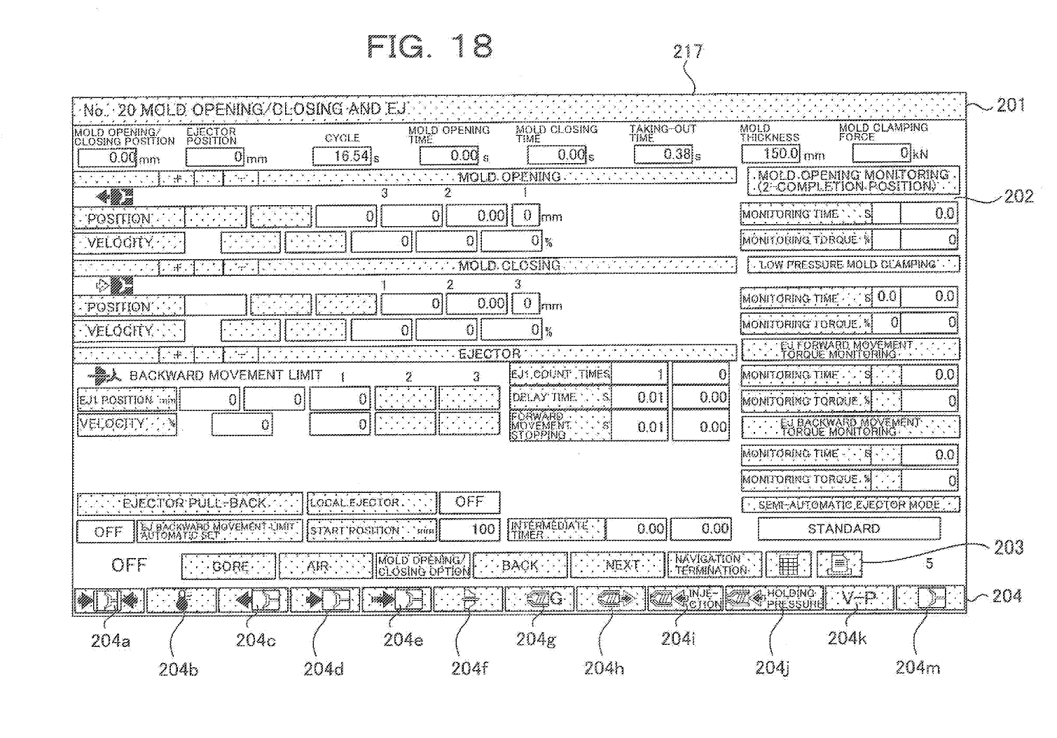

When the screen displayed on the display portion 30 is changed to the temperature setting screen 211, only setting value display fields in the temperature setting screen 211 and setting value display fields for the heaters 1 to 5 and the hopper are color-displayed in a color different from the surrounding. The operator inputs required setting values in the setting value display fields. Thus, setting of the setting values in the temperature setting screen 211 is completed. When “next” displayed in the temperature setting screen 211 is then selected, the screen displayed on the display portion 30 is changed to the mold opening/closing and EJ screen 217 in FIG. 18.

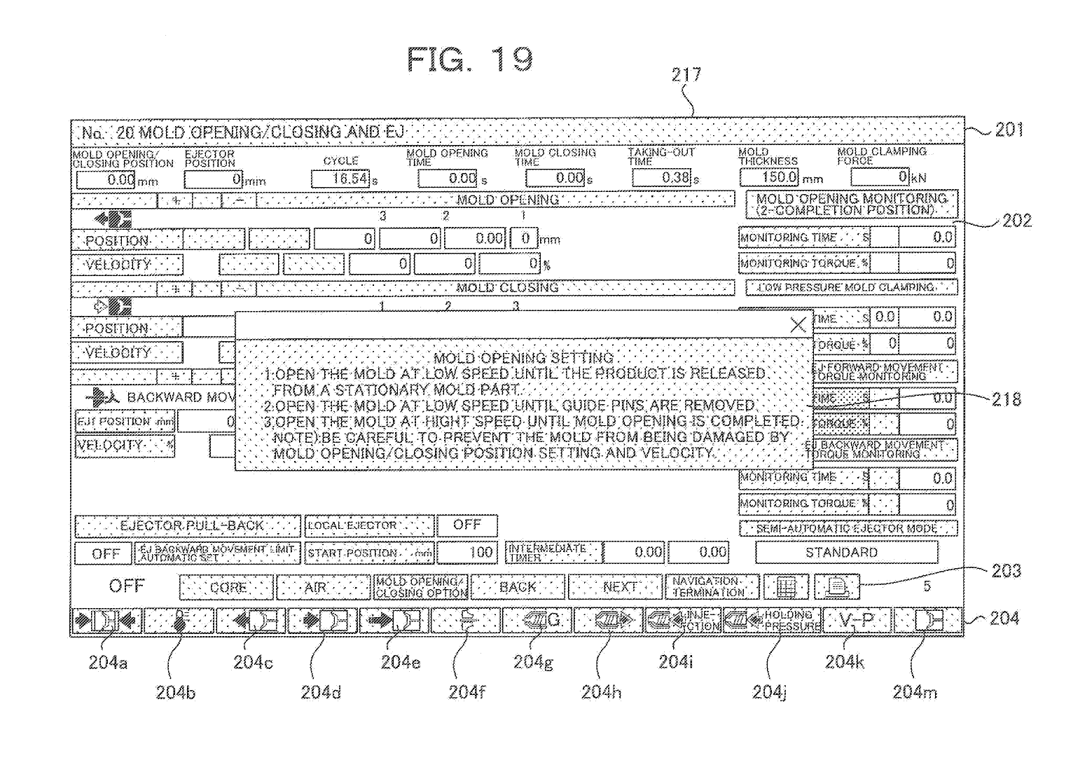

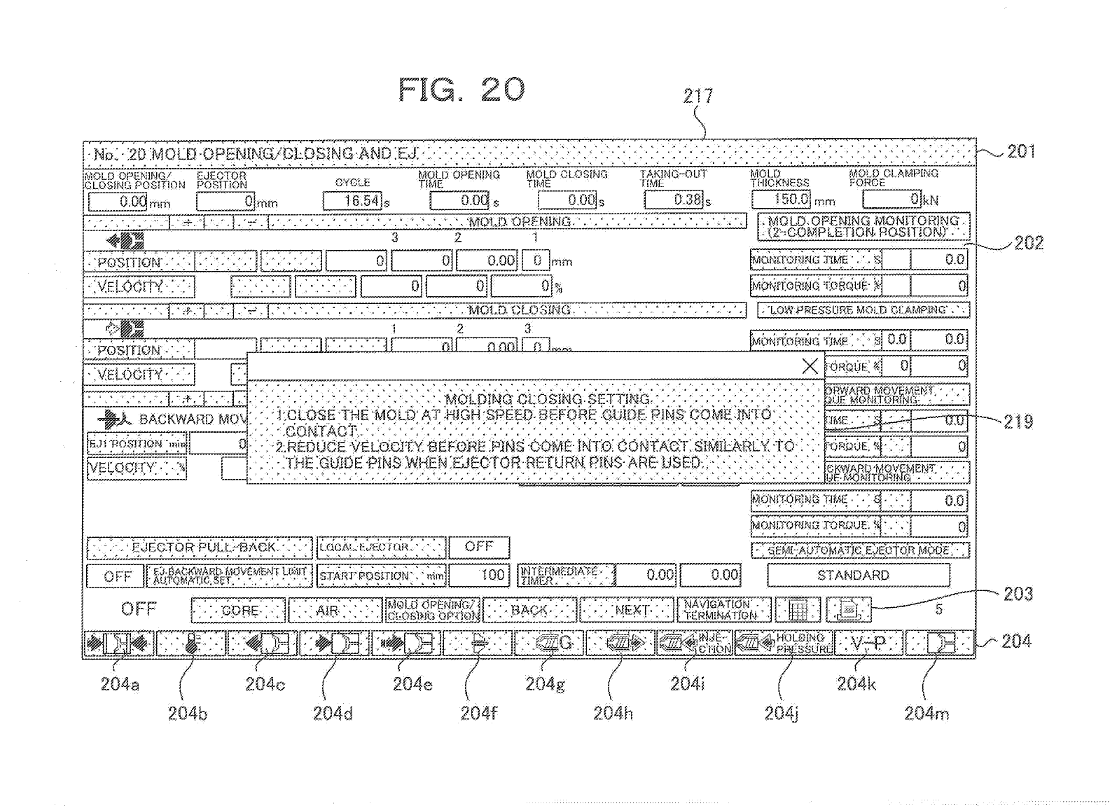

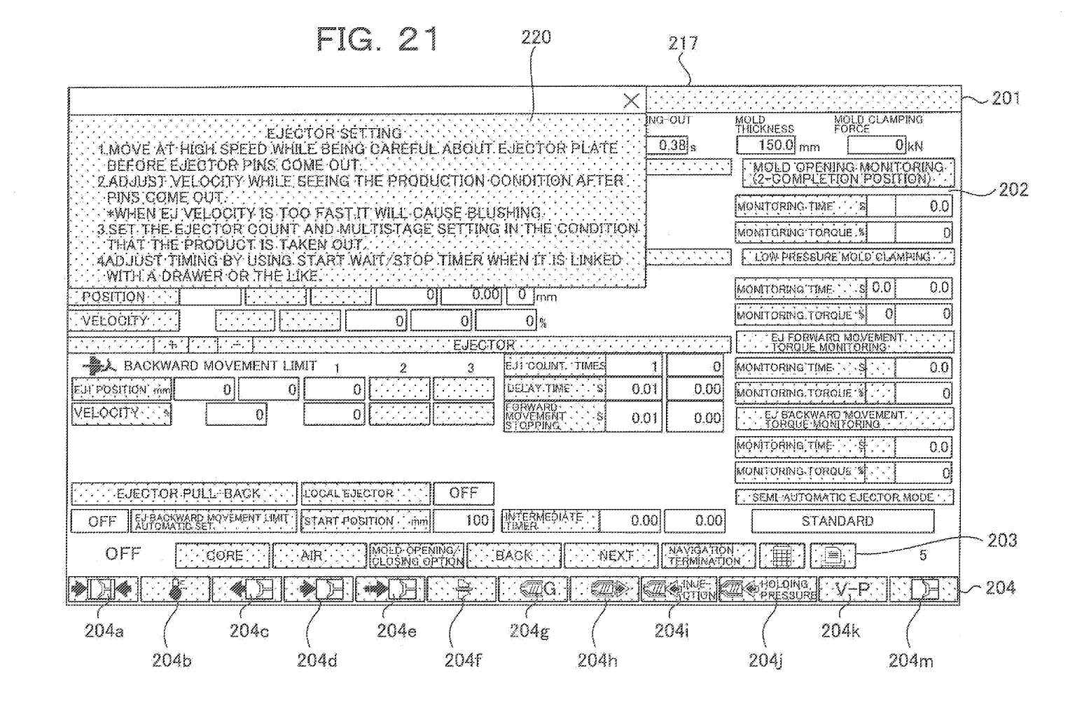

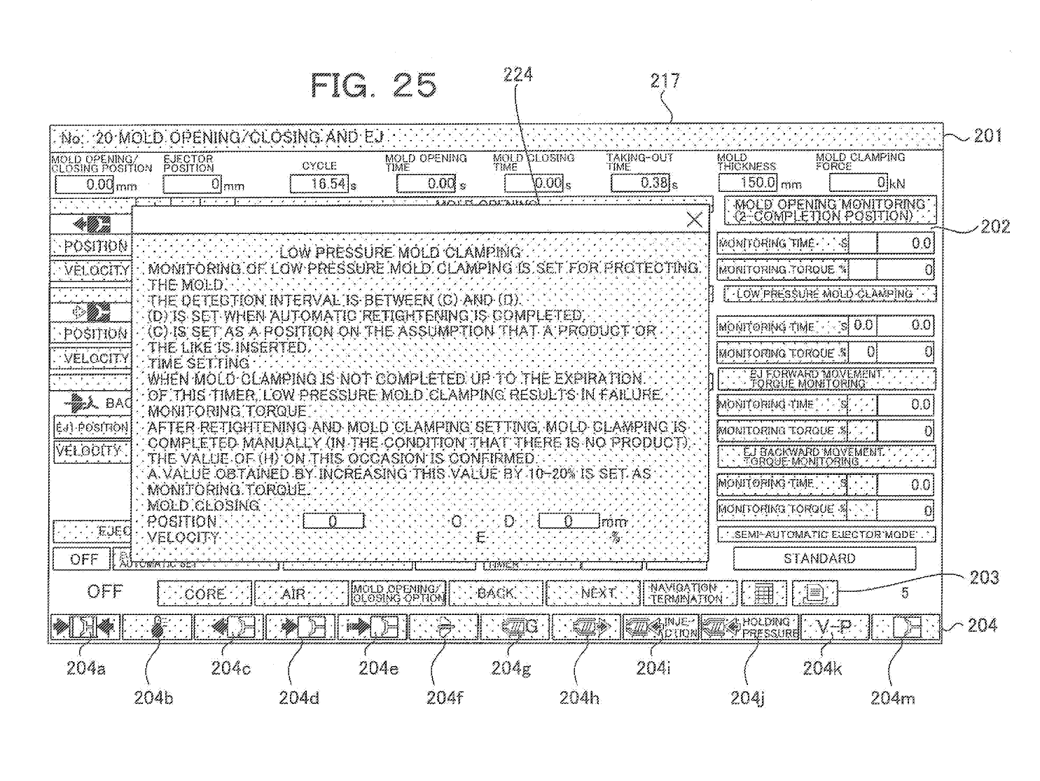

The mold opening/closing and EJ screen 217 is a screen for setting the positions and velocities of mold opening/closing and product taking-out. As shown in FIG. 18, heading fields of mold opening/closing position, ejector position, cycle time, mold opening time, mold closing time, taking-out time, mold thickness, mold clamping force and mold opening, heading fields of mold opening position, mold opening velocity, mold opening monitoring time, mold opening monitoring torque and mold closing, heading fields of mold closing position, mold closing velocity and low pressure mold clamping, heading fields of low pressure mold clamping monitoring time, low pressure mold clamping monitoring torque, EJ1 position, ejector velocity, EJ1 count, delay time, forward movement stopping, eject forward movement monitoring time and eject, and display fields of eject forward movement monitoring torque, eject backward movement monitoring time, eject backward movement monitoring torque and intermediate timer are displayed. When the operator selects the heading field of mold opening by using the input portion 40 after the screen displayed on the display portion 30 is changed to the mold opening/closing and EJ screen 217, a description 218 of mold opening setting is displayed as a relevant item in the mold opening/closing and EJ screen 217 as shown in FIG. 19. By pushing down an “X” mark displayed in the right upper portion, this description 218 can be erased from the screen. Similarly, when the operator selects the heading field of mold closing, the heading field of eject or the heading field of low pressure mold clamping displayed in the mold opening/closing and EJ screen 217, a description 219 of mold closing setting shown in FIG. 20, a description 220 of eject setting shown in FIG. 21 or a description 224 of low pressure mold clamping shown in FIG. 25 is displayed. By pushing an “X” mark displayed in the right upper portion, each of the descriptions 219, 220 and 224 can be erased from the screen.

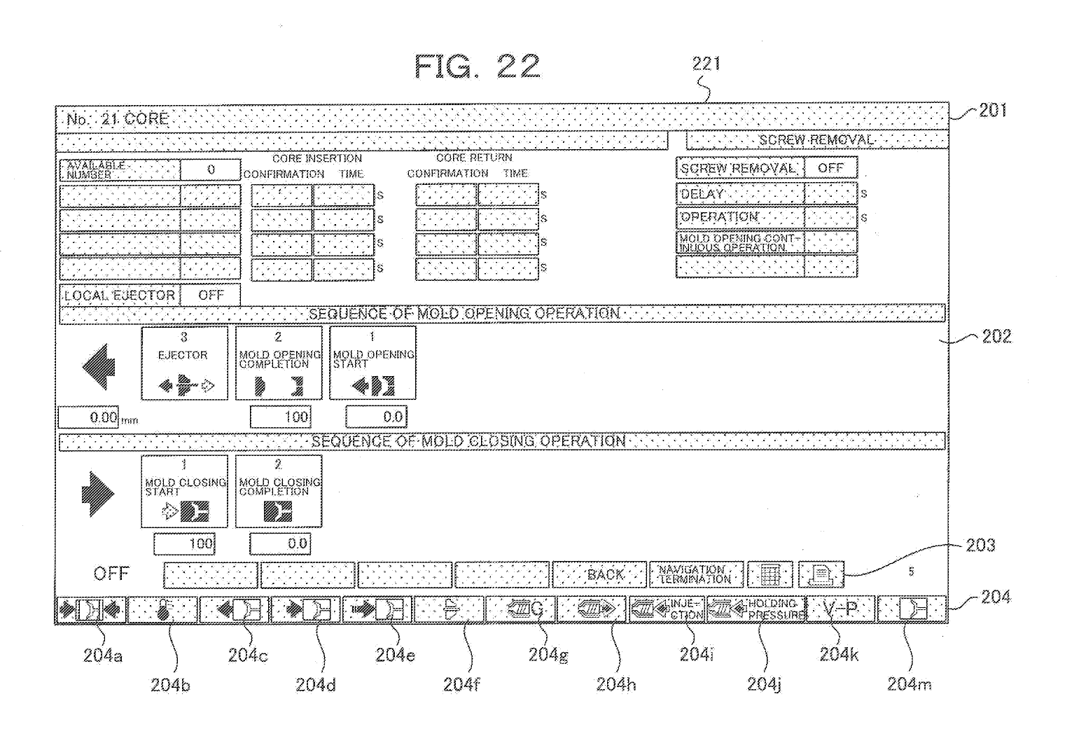

When the screen displayed on the display portion 30 is changed to the mold opening/closing and EJ screen 217, the respective display fields of mold opening position, mold opening velocity, mold closing position, mold closing velocity, low pressure mold clamping monitoring time, low pressure mold clamping monitoring torque, EJ1 position and ejector velocity are color-displayed in a color different from the surrounding, and the heading fields (character portions) of mold opening position and mold opening velocity are color-displayed in a color different from the surrounding. The operator inputs required setting values in the display fields of mold opening position and mold opening velocity by referring to the color display of the heading fields. When the “next” button displayed in the mold opening/closing and EJ screen 217 is then pushed down, the heading fields of mold closing position and mold closing velocity are color-displayed in a color different from the surrounding. Accordingly, the operator inputs required setting values in the display fields of mold closing position and mold closing velocity. When the “next” button displayed in the mold opening/closing and EJ screen 217 is then pushed down, the heading fields of low pressure mold clamping monitoring time and low pressure mold clamping monitoring torque are color-displayed in a color different from the surrounding. Accordingly, the operator inputs required setting values in the display fields of low pressure mold clamping monitoring time and low pressure mold clamping monitoring torque. When the “next” button displayed in the mold opening/closing and EJ screen 217 is then pushed down, the heading fields of EJ1 position and ejector velocity are color-displayed in a color different from the surrounding. Accordingly, the operator inputs required setting values in the display fields of EJ1 position and ejector velocity. Thus, setting of the setting values in the mold opening/closing and EJ screen 217 is completed. Whenever setting of mold opening position and mold opening velocity, setting of mold closing position and mold closing velocity, setting of low pressure mold clamping monitoring time and low pressure mold clamping monitoring torque and setting of EJ position and ejector velocity are performed, the colors of mold opening display 204c, mold closing display 204d, low pressure mold clamping display 204e and eject display 204f of the indicator 204 are successively changed to a color different from the surrounding. When “core” displayed in the mold opening/closing and EJ screen 217 is then selected, the screen displayed on the display portion 30 is changed to a core screen 221 in FIG. 22. Also in this case, by pushing down the “back” button displayed in the mold opening/closing and EJ screen 217, the current display field can go back to the previous display field.

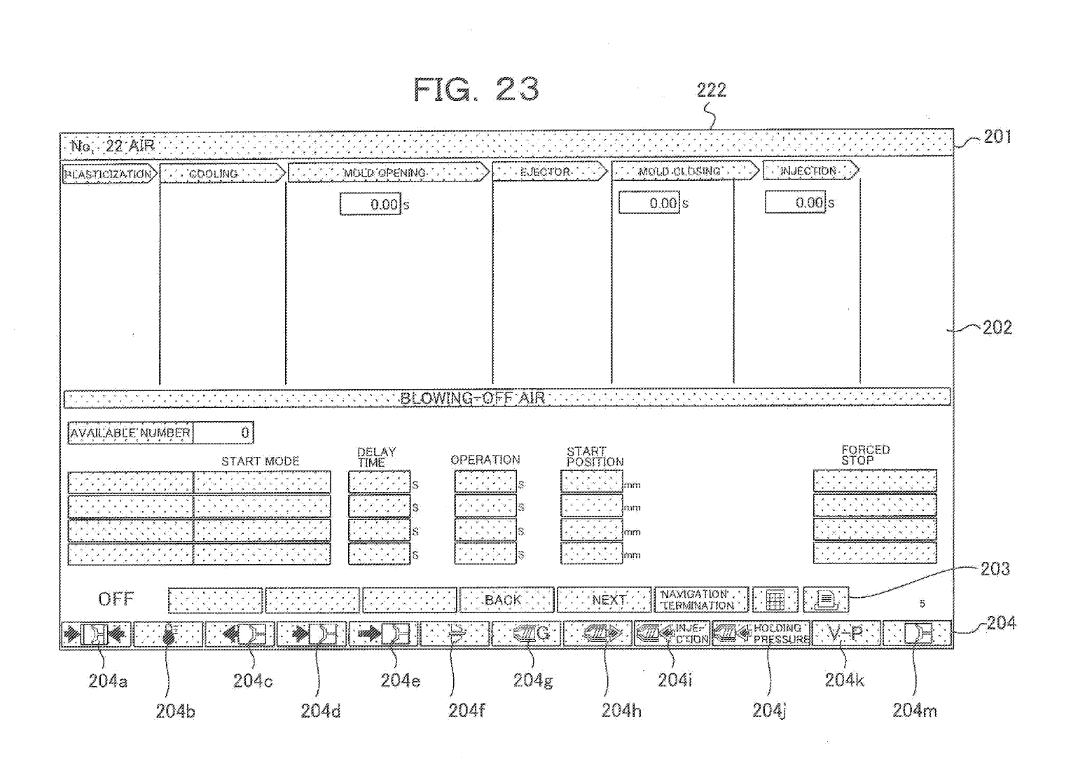

The core screen 221 is a screen for setting a core in the mold. As shown in FIG. 22, respective display fields of using number, unscrew, local ejector, mold opening start, mold opening completion, ejector, mold closing start and mold closing completion are displayed. When “back” displayed in the core screen 221 is selected after completion of setting of necessary items, the screen displayed on the display portion 30 goes back to the mold opening/closing and EJ screen 217 in FIG. 18. When the operator selects “air” displayed in the mold opening/closing and EJ screen 217, the screen displayed on the display portion 30 is changed to an air screen 222 in FIG. 23.

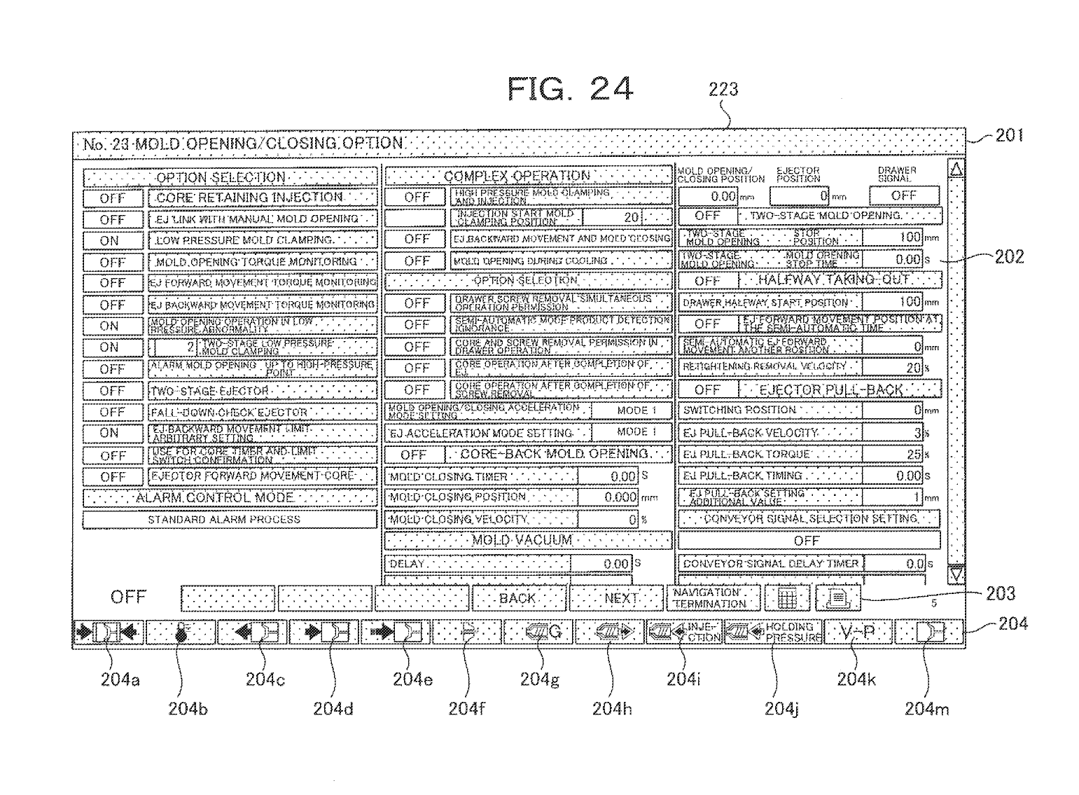

The air screen 222 is a screen for setting the timing of air blowing. As shown in FIG. 23, respective display fields of using number, mold opening delay time, mold opening operation, mold opening start position, mold closing delay time, mold closing operation, mold closing start position, injection delay time, injection operation and injection start position are displayed. A mold opening forced stop button, a mold closing forced stop button and an injection forced stop button are displayed as function buttons. When “back” displayed in the air screen 222 is selected after completion of setting of necessary items, the screen displayed on the display portion 30 goes back to the mold opening/closing and EJ screen 217 in FIG. 18. When the operator selects the “mold opening/closing option” displayed in the mold opening/closing and EJ screen 217, the screen displayed on the display portion 30 is changed to a mold opening/closing option screen 223 in FIG. 24.

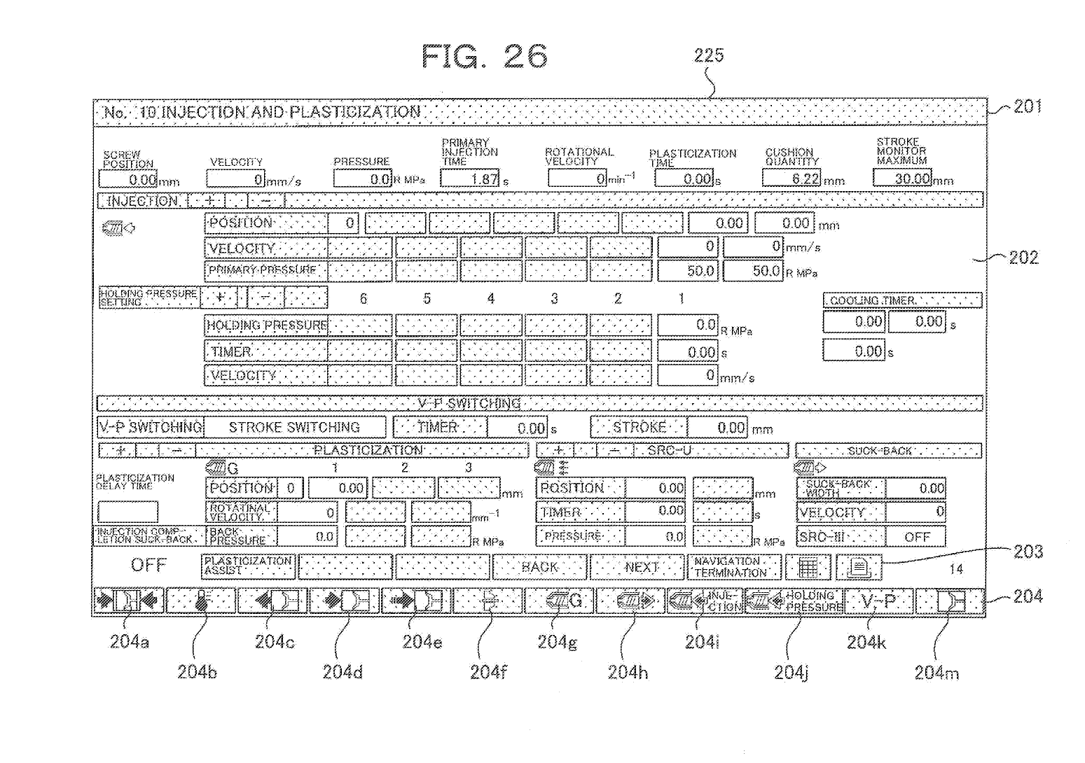

The mold opening/closing option screen 223 is a screen which enables more detailed setting of mold opening/closing and eject and in which various items exemplified in FIG. 24 are displayed. When the operator selects one from the various items displayed in FIG. 24, a screen corresponding to the selected item is displayed in the mold opening/closing and EJ screen 217 so that a setting value for the item can be inputted. Incidentally, selection of the core screen 221, the air screen 222 and the mold opening/closing option screen 223 is so arbitrary that setting of molding conditions can be completed without selection of these in accordance with the molded article. When “next” displayed in the mold opening/closing and EJ screen 217 is selected, the screen displayed on the display portion 30 is changed to an injection and plasticization screen 225 in FIG. 26 and the color of plasticization display 204g of the indicator 204 is changed to a color different from the surrounding.

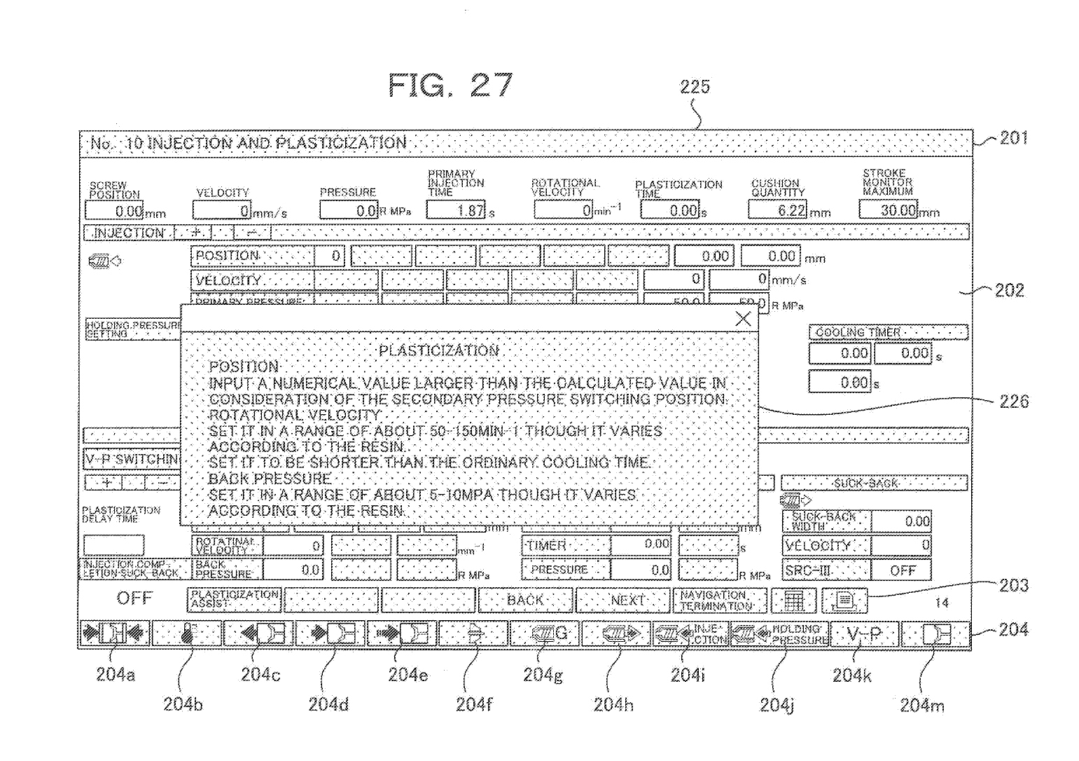

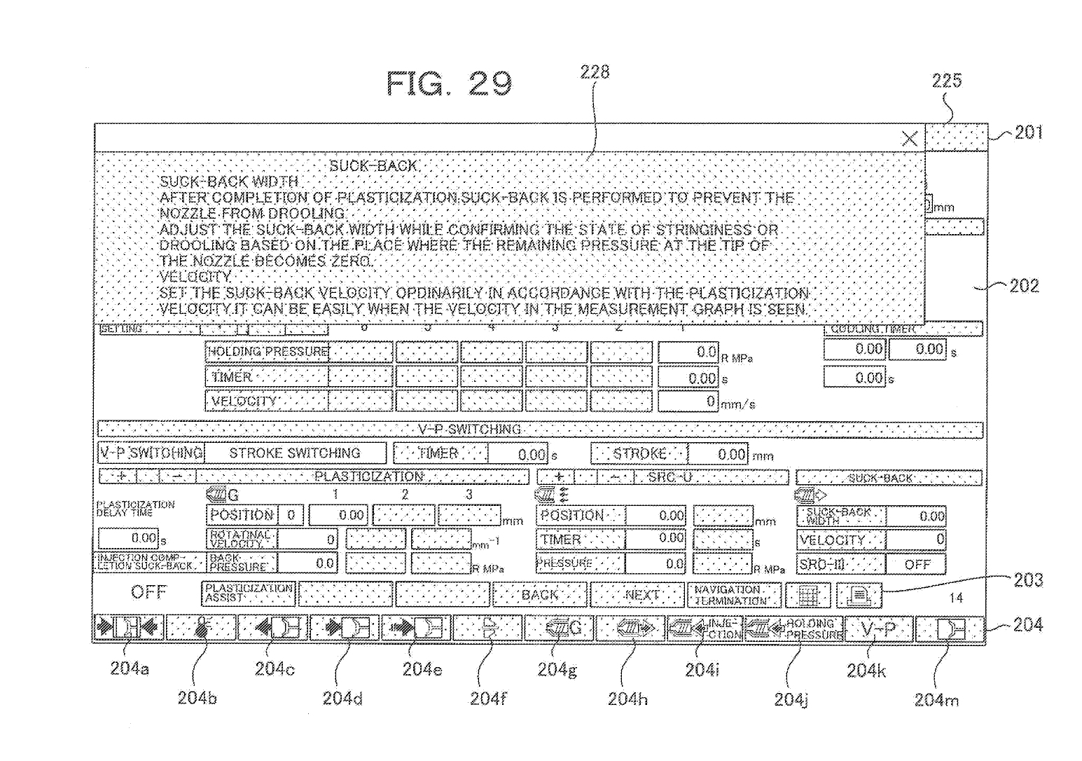

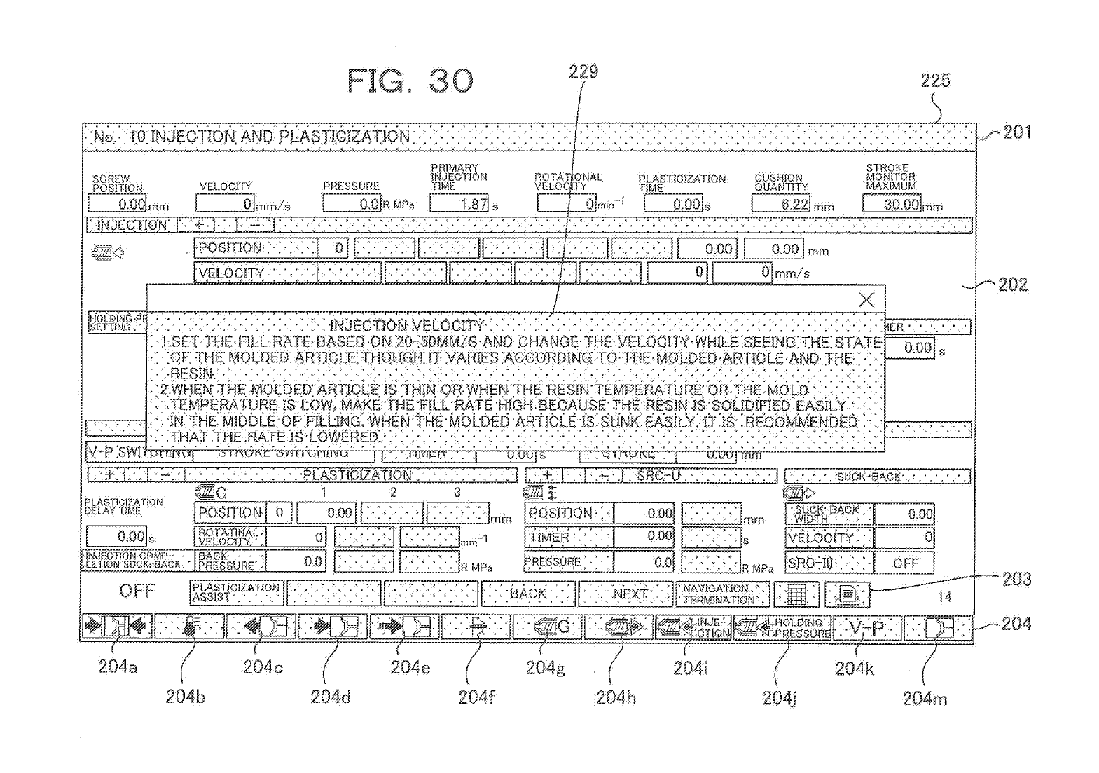

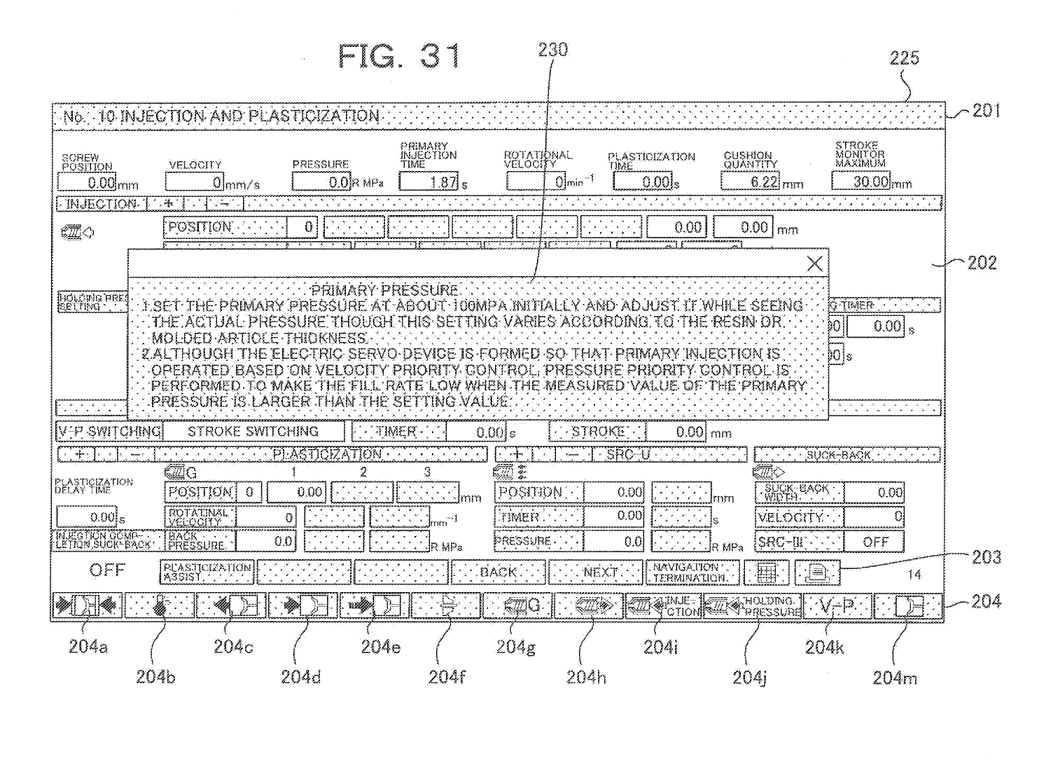

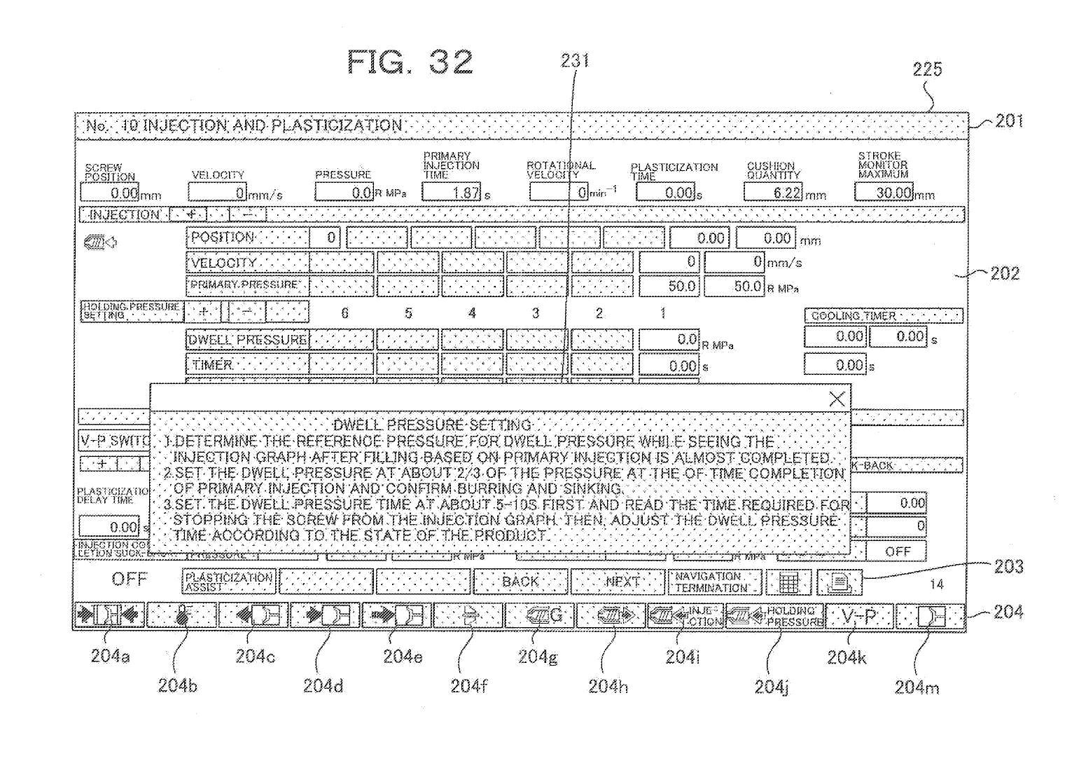

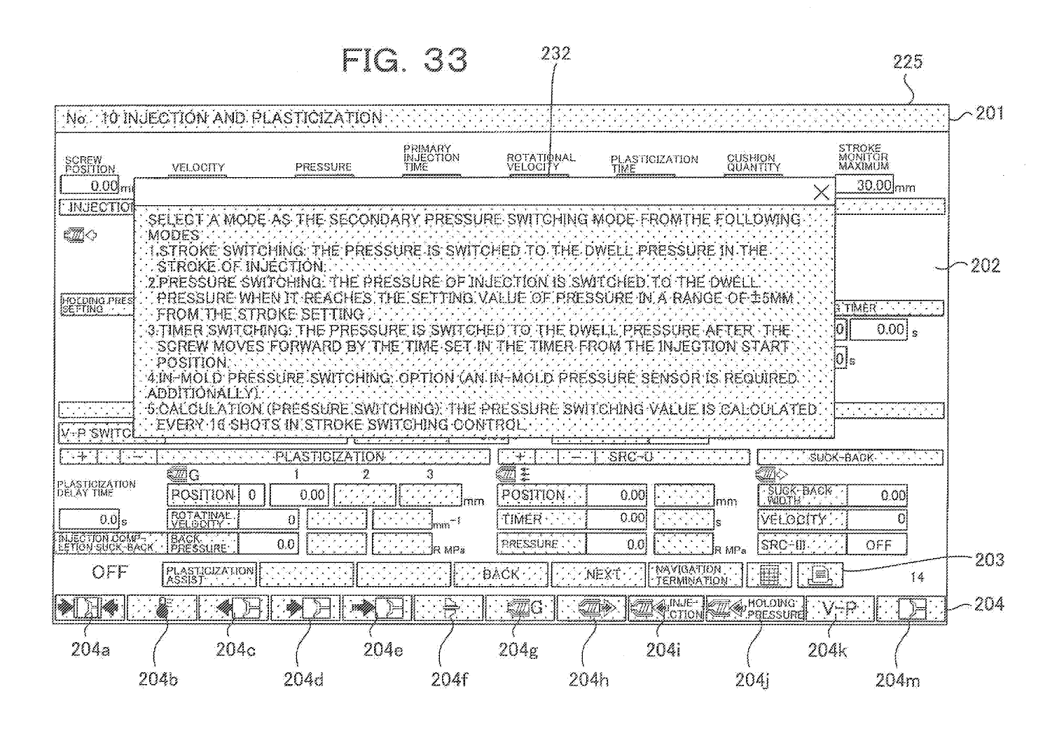

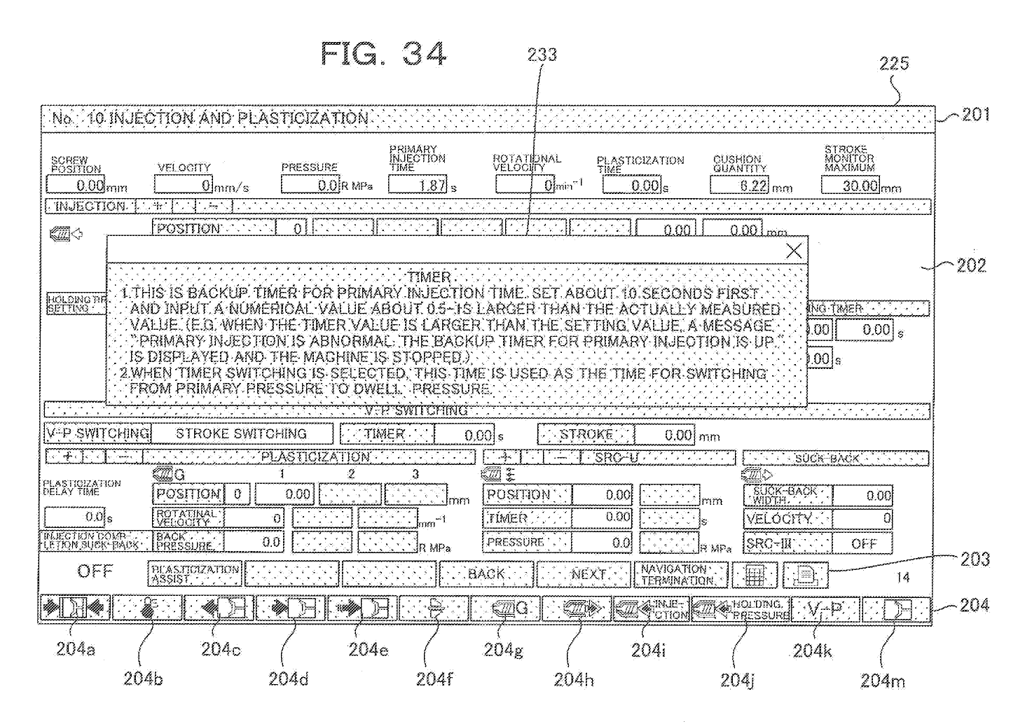

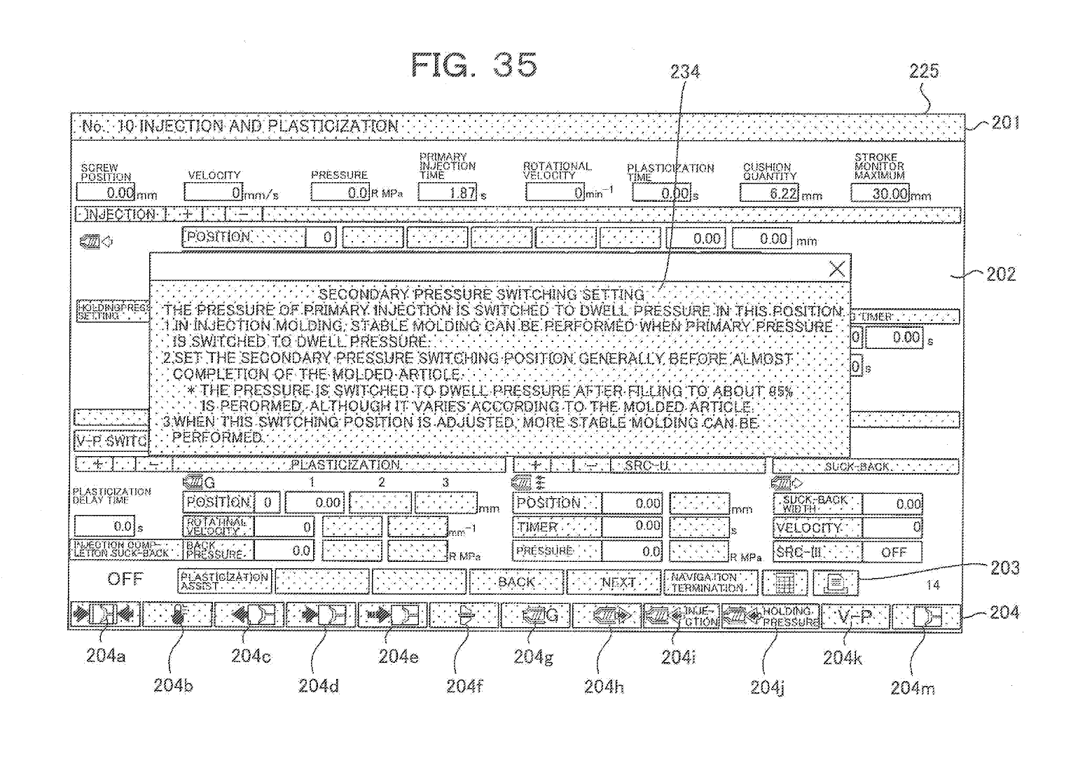

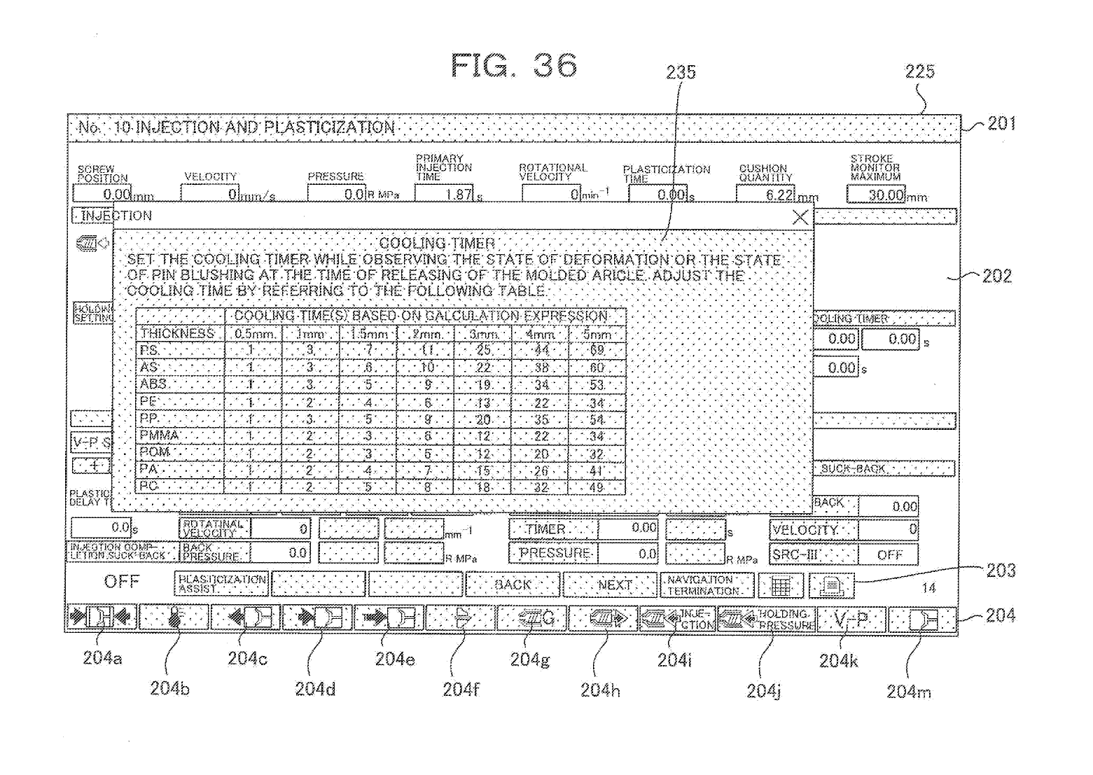

The injection and plasticization screen 225 is a screen for setting injection conditions, holding pressure conditions and plasticization conditions of raw material resin. As shown in FIG. 26, heading fields of screw position, velocity, pressure, primary injection time, rotational velocity, plasticization time, cushioning quantity, stroke monitoring maximum value and injection, heading fields of injection position, injection velocity, injection primary pressure and holding pressure setting, heading fields of holding pressure, holding pressure timer, holding pressure velocity and V-P switching, heading fields of stroke switching, timer, stroke and plasticization, heading fields of plasticization delay time, plasticization position, plasticization rotational velocity, plasticization back pressure, injection position, injection timer, injection pressure and suck-back and respective display fields of suck-back width, suck-back velocity and cooling timer are displayed. When the operator selects the heading field of plasticization after the screen displayed on the display portion 30 is changed to the injection and plasticization screen 225, a description 226 of plasticization is displayed as a relevant item in the injection and plasticization screen 225, as shown in FIG. 27. When the operator selects an “X” mark displayed in the description 226, the description 226 disappears and the current screen goes back to the injection and plasticization screen 225 in FIG. 26. Similarly to this, when the operator pushes down a suitable heading field or pictorial symbol displayed in the injection and plasticization screen 225, a description corresponding to the heading field or pictorial symbol can be displayed on the injection and plasticization screen 225. FIG. 29 shows a description field 228 of suck-back, FIG. 30 shows a description field 229 of injection velocity, FIG. 31 shows a description field 230 of primary pressure, FIG. 32 shows a description field 231 of pressure retaining setting, FIG. 33 shows a description field 232 of secondary pressure switching mode, FIG. 34 shows a description field 233 of primary injection time, FIG. 35 shows a description field 234 of V-P switching setting, and FIG. 36 shows a reference table 235 of cooling timer. When the operator selects an “X” mark displayed in the right upper portion of each description, each of the descriptions 228 to 235 can be erased.

When the screen displayed on the display portion 30 is changed to the injection and plasticization screen 225, the heading fields of injection position, injection velocity, injection primary pressure, holding pressure, holding pressure timer, holding pressure velocity and V-P switching and the display fields of timer, stroke, plasticization position, plasticization rotational velocity, plasticization back pressure, suck-back width, suck-back velocity and cooling timer are color-displayed in a color different from the surrounding, and the respective heading fields (character portions) of plasticization position, plasticization rotational velocity and plasticization back pressure are color-displayed in a color different from the surrounding. The operator inputs required setting values in the display fields of plasticization position, plasticization rotational velocity and plasticization back pressure by referring to the color display of the heading fields. When the “next” button displayed in the injection and plasticization screen 225 is then pushed down, the respective heading fields of suck-back width and suck-back velocity are color-displayed in a color different from the surrounding. Accordingly, the operator inputs required setting values in the respective display fields of suck-back width and suck-back velocity. When the “next” button displayed in the injection and plasticization screen 225 is then pushed down, the respective heading fields of injection position, injection velocity and injection primary pressure are color-displayed in a color different from the surrounding. Accordingly, the operator inputs required setting values in the injection position, injection velocity and injection primary pressure. When the “next” button displayed in the injection and plasticization screen 225 is then pushed down, the heading fields of holding pressure, holding pressure timer and holding pressure velocity are color-displayed in a color different from the surrounding. Accordingly, the operator inputs required setting values in the respective display fields of holding pressure, holding pressure timer and holding pressure velocity. When the “next” button displayed in the injection and plasticization screen 225 is then pushed down, the heading fields of V-P switching timer and V-P switching stroke are color-displayed in a color different from the surrounding. Accordingly, the operator inputs required setting values in the respective display fields of V-P switching timer and V-P switching stroke. When the “next” button displayed on the injection and plasticization screen 225 is then pushed down, the heading field of cooling timer is color-displayed in a color different from the surrounding. Accordingly, the operator inputs required setting values in the display field of cooling timer. Thus, setting of the setting values in the injection and plasticization screen 225 is completed. Whenever the plasticization conditions, the suck-back conditions, the injection conditions, the holding pressure conditions, the V-P switching conditions and the cooling timer conditions are inputted, the colors of plasticization condition setting display 204g, suck-back condition setting display 204h, injection condition setting display 204i, holding pressure condition setting display 204j, V-P switching condition setting display 204k and cooling timer 204m of the indicator 204 change successively to a color different from the surrounding. Incidentally, by pushing down the “back” button displayed in the injection and plasticization screen 225, the current item can go back to the previous setting item suitably.

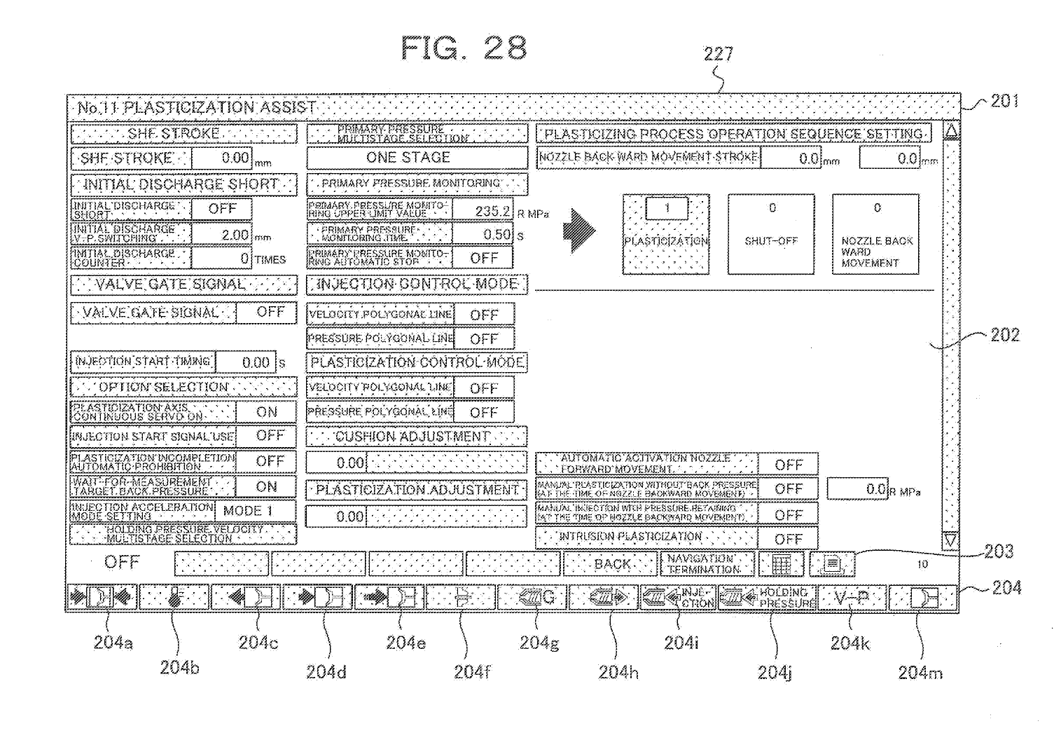

When the operator selects plasticization assist displayed in the injection and plasticization screen 225 in the condition that the injection and plasticization screen 225 is displayed on the display portion 30, the screen displayed on the display portion 30 is changed to a plasticization assist screen 227 in FIG. 28. The plasticization assist screen 227 is a screen which enables more detailed setting of plasticization conditions. As shown in FIG. 28, respective display fields of SHF stroke, initial discharge V-P switching, initial discharge counter, injection start timing, primary pressure monitoring upper limit value, cushioning adjustment, plasticization adjustment and nozzle backward movement stroke are displayed. In the injection and plasticization screen 225, the selection fields of initial discharge short, valve gate signal, plasticization axis continuous servo ON, injection start signal use, plasticization incompletion automatic prohibition, wait-for-measurement target back pressure, injection acceleration mode setting, primary pressure multistage selection, primary pressure monitoring automatic stop, injection control mode velocity polygonal line, injection control mode pressure velocity polygonal line, plasticization control mode velocity polygonal line, plasticization control mode pressure velocity polygonal line, automatic activation nozzle forward movement, manual plasticization without back pressure, manual injection with holding pressure and intrusion plasticization are also displayed. In the plasticization assist screen 227, the operator selects the respective selection fields and inputs required setting values in the respective display fields. Thus, setting of the setting values in the plasticization assist screen 227 is completed. When “back” displayed in the plasticization assist screen 227 is then selected, the screen displayed on the display portion 30 goes back to the injection and plasticization screen 225 in FIG. 26.

When the “navigation termination” button displayed in the injection and plasticization screen 225 is pushed down after completion of setting of all molding conditions, a message “Do you need plasticization assist?” is displayed on the injection and plasticization screen 225. When the operator selects “navigation termination” again, the screen displayed on the display portion 30 is changed to the exchange screen 209 shown in FIG. 10, and a message “Setting is completed. Execute molding after purging.” is displayed on the exchange screen 209. When the option confirmation button displayed in the injection and plasticization screen 225 is pushed down, the screen displayed on the display portion can be made to go back to the option confirmation screen 207 shown in FIG. 8.

As described above, in the molding machine according to this embodiment, when molding navigation is activated, setting screens required for setting molding conditions are displayed in a predetermined sequence on the display portion and setting item display fields in which the molding conditions are to be inputted in the displayed setting screens are displayed in a color different from the surrounding. Accordingly, the operator can complete the setting of the molding conditions by a simple operation of inputting predetermined setting values in the displayed sequence in the setting item display fields displayed in a color different from the surrounding. All the molding conditions required for operating the molding machine can be set exhaustively without requiring any special skill, so that the setting of the molding conditions can be performed highly efficiently and reliably.

Although the aforementioned embodiment has been described in the case where an injection molding machine is taken as an example, the gist of the invention is not limited thereto. For example, the invention can be applied directly to another molding machine such as a die casting machine.

### INDUSTRIAL APPLICABILITY

The present invention can be applied to a molding machine such as an injection molding machine or a die casting machine.

### REFERENCE SIGNS LIST

1 injection molding machine
10 molding mechanism portion
11 injection unit
12 mold clamping unit
121 mold
20 microcomputer portion
21 respective drive portion input/output portion
22 respective drive portion control portion
23 storage portion
24 control portion
25 display processing portion
26 input processing portion
27 external memory input/output processing portion
30 display portion
40 input portion
50 input/output terminal portion
70 external memory
101 menu screen
102 initial screen of molding navigation
207 option confirmation screen
208 calculation screen
209 exchange screen
211 temperature setting screen
217 mold opening/closing and EJ screen
221 core screen
222 air screen
223 mold opening/closing option screen
225 injection and plasticization screen

1. A molding machine for repeating respective processes of mold closing, injection, mold opening and product taking-out according to a control signal outputted from a control portion, comprising a display portion, an input portion and a storage portion for setting molding conditions which are conditions for driving respective portions of the molding machine in the respective processes, characterized in that:
the storage portion stores a molding condition automatic setting mode for automatically setting the molding conditions; and the control portion performs control of switching a screen displayed on the display portion to a first setting screen of the molding condition automatic setting mode and color-displaying display fields of setting items for inputting the molding conditions in the first setting screen when an operator operates the input portion to select the molding condition automatic setting mode from a menu screen displayed on the display portion, and of switching the screen displayed on the display portion to a second setting screen of the molding condition automatic setting mode and color-displaying display fields of setting items for inputting the molding conditions in the second setting screen when the operator operates the input portion to select a next display request field displayed in the first setting screen, up to a final setting screen.

2. A molding machine according to claim 1, characterized in that: when the molding condition automatic setting mode is selected, the control portion switches the screen displayed on the display portion to an initial screen of the molding condition automatic setting mode and successively displays a selection field as to whether all setting values to be inputted in accordance with the molding condition automatic setting mode are set to zero or not, and a selection field as to whether the molding condition automatic setting mode is terminated or not, as part of the initial screen before switching the screen displayed on the display portion to the first setting screen.

3. A molding machine according to claim 1, characterized in that: display of a mold clamping force calculation and stroke calculation screen, display of an exchange screen, display of an option confirmation screen, display of a temperature setting screen, display of a mold opening/closing and product taking-out screen and display of an injection and plasticization screen are performed in this order as display of the setting screens in the automatic setting mode.

4. A molding machine according to claim 1, characterized in that: the control portion displays a description field of a relevant item as part of each of the setting screens.

5. A molding machine according to claim 3, characterized in that: core, air and mold opening/closing option selection fields are displayed in the mold opening/closing and product taking-out screen; and when one of the selection fields is selected by operation of the input portion, the control portion switches the screen displayed on the display portion to one of a core setting screen, an air setting screen and a mold opening/closing option setting screen in accordance with the selected selection field.

6. A molding machine according to claim 3, characterized in that: a plasticization assist selection field and an option confirmation selection field are displayed in the injection and plasticization screen; when the plasticization assist selection field is selected by operation of the input portion, the control portion switches the screen displayed on the display portion to a plasticization assist setting screen; and when the option confirmation selection field is selected by operation of the input portion, the control portion switches the screen displayed on the display portion to an option confirmation screen.

7. A molding machine according to claim 1, characterized in that: a previous display request field is displayed in each of the first to last setting screens; and when the operator operates the input portion to select the previous display request field, the control portion switches the screen displayed on the display portion to a previous setting screen.

8. A molding machine according to claim 1, characterized in that: an indicator indicating the progress of the molding condition automatic setting mode is displayed in each of the first to last setting screens; and whenever the setting screen displayed on the display portion is switched, the color of the indicator is changed in accordance with the setting screen after switching.

9. A molding machine according to claim 1, characterized in that: the control portion performs control of color-displaying all display fields of setting items simultaneously and color-displaying a heading field of a first setting item for inputting the molding conditions when the setting screen having the display fields of setting items is displayed on the display portion, and canceling the color-display of the heading field of the first setting item and color-displaying a heading field of a second setting item when the operator operates the input portion to select a next display request field displayed in the setting screen, up to display of the last setting item; when the operator operates the input portion to select a next display request field displayed in the setting screen while a heading field of the last setting item is color-displayed, the control portion switches the screen displayed on the display portion to a next setting screen; when the operator operates the input portion to select a previous display request field displayed in the setting screen while a heading field of the second setting item or a setting item after the second setting item is color-displayed, the control portion cancels the color-display of the heading field of the second setting item or the setting item after the second setting item and color-displays the heading field of the previous setting item; and when the operator operates the input portion to select a previous display request field displayed in the setting screen while the heading field of the first setting item is color-displayed, the control portion switches the screen displayed on the display portion to a next setting screen.
